(19) United States
(12) Patent Application Publication
(10) Pub. No.: US 2026/0091385 A1
(43) Pub. Date: Apr. 2, 2026

(54) APPARATUS AND METHODS FOR SAMPLE LOADING

(71) Applicant: ILLUMINA, INC., San Diego, CA (US)

(72) Inventors: Paul SanGiorgio, San Diego, CA (US); Brooke Zampell, San Diego, CA (US); Bradley Drews, Poway, CA (US)

(21) Appl. No.: 19/304,301

(22) Filed: Aug. 19, 2025

Related U.S. Application Data
(60) Provisional application No. 63/701,098, filed on Sep. 30, 2024.

(51) Int. Cl. B01L 3/00

(52) U.S. Cl. CPC B01L 3/502715; B01L 3/50273; B01L 2200/027; B01L 2200/16; B01L 2300/0877; B01L 2400/0487

(57) ABSTRACT

Systems, apparatus, and methods for sample loading are disclosed. In accordance with one implementation, the system includes an interface configured to receive a substrate including an active area. A pump is configured to flow a reagent from a reagent reservoir and a sample slug of the sample of interest toward the active area. An optical assembly includes an objective and a focus tracking module that is configured to detect a position of a meniscus of the reagent between the reagent and the sample slug. The pump is configured to flow the sample slug over the active area based on the position of the meniscus. The focus tracking module is configured to determine a z-position of the interface and the optical assembly is configured to adjust a position of the objective based on the z-position determined.

### BACKGROUND

A sample may be loaded onto a substrate during an analysis using an analyzer. The substrate may be implemented by a microfluidic device such as a flow cell. The analyzer may be implemented by a sequencing platform.

### SUMMARY

Shortcomings of the prior art can be overcome and benefits as described later in this disclosure can be achieved through the provision of apparatus and methods for sample loading. Various implementations of the apparatus and methods are described below, and the apparatus and methods, including and excluding the additional implementations enumerated below, in any combination (provided these combinations are not inconsistent), may overcome these shortcomings and achieve the benefits described herein.

In accordance with a first implementation, a system comprises an interface configured to receive a substrate including an active area. A pump is configured to flow a reagent from a reagent reservoir toward the active area and to flow a sample slug of a sample of interest toward the active area. An optical assembly includes an objective and a focus tracking module configured to detect a position of a meniscus of the reagent between the reagent and the sample slug. The pump is configured to flow the sample slug over the active area based on the position of the meniscus. The focus tracking module is configured to determine a z-position of the interface and the optical assembly is configured to adjust a position of the objective based on the z-position determined.

In accordance with a second implementation, an apparatus comprises a flow cell having a channel, the channel including an active area, and a sample cartridge configured to retain a sample of interest. A system of the apparatus comprises a pump configured to flow a reagent from a reagent reservoir into the channel of the flow cell and to flow a sample slug of the sample of interest into the channel of the flow cell and an optical assembly including an objective and a focus tracking module configured to detect a position of a meniscus of the reagent between the reagent and the sample slug. The pump is configured to flow the sample slug over the active area of the channel of the flow cell based on the position of the meniscus.

In accordance with a third implementation, an apparatus comprises a flow cell having a channel, the channel including an active area, and a system comprising a pump configured to flow a reagent from a reagent reservoir into the channel of the flow cell and to flow a sample slug of a sample of interest into the channel of the flow cell and an optical assembly including a sensor configured to detect a position of a meniscus of the reagent between the reagent and the sample slug. The pump is configured to flow the sample slug over the active area of the channel of the flow cell based on the position of the meniscus.

In further accordance with the foregoing first, second, and/or third implementations, a system/apparatus may further include or comprise any one or more of the following.

In an implementation, the focus tracking module is configured to detect the position of the meniscus within the channel of the flow cell.

In another implementation, a first air slug is positioned on a first side of the sample slug, between the sample slug and the reagent, and a second air slug is positioned on a second side of the sample slug, opposite the first side, between the sample slug and the reagent.

In another implementation, the meniscus is located between the reagent and the first air slug.

In another implementation, the pump is configured to position the first air slug and the second air slug outside of the active area of the channel of the flow cell.

In another implementation, the flow cell comprises a plurality of channels and the focus tracking module is configured to sweep across the plurality of channels to detect the position of the meniscus of the reagent between the reagent and the sample slug in each channel of the plurality of channels.

In another implementation, the system comprises a flow cell interface configured to receive the flow cell, the focus tracking module is configured to determine a z-position of the flow cell interface, and the optical assembly is configured to adjust a position of the objective based on the z-position determined.

In another implementation, the system comprises a sample cartridge interface configured to receive a sample cartridge, a sample loading manifold assembly, a first fluidic line fluidly coupling the interface and the sample loading manifold assembly; and a second fluidic line fluidly coupling the sample loading manifold assembly and the sample cartridge interface.

In another implementation, the system comprises a flow cell interface, a sample cartridge interface configured to receive the sample cartridge, and a sample loading manifold assembly. A first fluidic line fluidly couples the flow cell interface and the sample loading manifold assembly and a second fluid line fluidly couples the sample loading manifold assembly and the sample cartridge interface.

In another implementation, a total length of the first fluidic line and the second fluidic line together is greater than or equal to about 1 meter and less than or equal to about 3 meters.

In another implementation, the total length of the first fluidic line and the second fluidic line is approximately 2 meters.

In another implementation, the pump is a syringe pump.

In another implementation, the pump is configured to push the sample slug into the channel of the flow cell.

In another implementation, a volume of the sample slug is greater than or equal to about 100 microliters and less than or equal to about 200 microliters.

In another implementation, the volume of the sample slug is approximately 150 microliters.

In another implementation, the sensor is configured to detect the position of the meniscus within the channel of the flow cell.

In another implementation, the flow cell comprises a plurality of channels and the sensor of the optical assembly is configured to sweep across the plurality of channels to detect the position of the meniscus of the reagent between the reagent and the sample slug in each channel of the plurality of channels.

In another implementation, the system comprises a flow cell interface configured to receive the flow cell, the sensor of the optical assembly is a focus tracking module configured to determine a z-position of the flow cell interface, and the optical assembly is configured to adjust a position of an objective of the optical assembly based on the z-position determined.

In accordance with a fourth implementation, a method comprises flowing a reagent from a reagent reservoir and a sample slug of a sample of interest into a channel of a flow cell; detecting a position of a meniscus of the reagent between the reagent and the sample slug; determining the position of the sample slug based on the detected position of the meniscus; and flowing the sample slug over an active area of the channel of the flow cell based on the determined position of the sample slug.

In further accordance with the fourth implementation, a method may further include or comprise any one or more of the following.

In one implementation, the position of the meniscus is detected within the channel of the flow cell.

In another implementation, the method comprises positioning a first air slug on a first side of the sample slug, between the sample slug and the reagent; and positioning a second air slug on a second side of the sample slug, opposite the first side, between the sample slug and the reagent.

In another implementation, the meniscus is located between the reagent and the first air slug.

In another implementation, the method comprises flowing the sample slug over the active area such that the first air slug and the second air slug are outside of the active area.

In another implementation, the method comprises flowing the reagent from the reagent reservoir into a second channel of the flow cell; flowing a second sample slug of a second sample of interest into the second channel of the flow cell; sweeping a focus tracking module across the channel and the second channel; detecting the position of the meniscus of the reagent between the reagent and the sample slug in the channel and a position of a second meniscus of the reagent between the reagent and the second sample in the second channel; determining the position of the sample slug and the position of the second sample slug based on the detected positions of the meniscus and the second meniscus; and flowing the sample slug over an active area of the channel and flowing the second sample slug over a second active area of the second channel based on the determined positions of the sample slug and the second sample slug.

In another implementation, the position of the meniscus is detected by a focus tracking module.

In another implementation, the method comprises determining a z-position of a flow cell interface, configured to receive the flow cell, with the focus tracking module and adjusting a position of an objective of an optical assembly based on the z-position determined.

In another implementation, the method comprises flowing the sample slug from the sample cartridge interface to the flow cell through at least one fluidic line.

In another implementation, a length of the at least one fluidic line is greater than or equal to about 1 meter and less than or equal to about 3 meters.

In another implementation, the length of the at least one fluidic line is approximately 2 meters.

In another implementation, the reagent and the sample slug are flowed into the channel of the flow cell via a pump.

In another implementation, the pump is a syringe pump.

In another implementation, the pump is configured to pull the sample slug into the channel of the flow cell.

In another implementation, a volume of the sample slug is greater than or equal to about 100 microliters and less than or equal to about 200 microliters.

In another implementation, the volume of the sample slug is approximately 150 microliters.

It should be appreciated that all combinations of the foregoing concepts and additional concepts discussed in greater detail below (provided such concepts are not mutually inconsistent) are contemplated as being part of the subject matter disclosed herein and/or may be combined to achieve the particular benefits of a particular aspect. In particular, all combinations of claimed subject matter appearing at the end of this disclosure are contemplated as being part of the subject matter disclosed herein.

### BRIEF DESCRIPTION OF THE DRAWINGS

FIG. 1 illustrates a schematic diagram of an implementation of a system in accordance with the teachings of this disclosure;

FIG. 2 illustrates an arrangement of a focus tracking module and a first implementation of a flow cell in the system of FIG. 1 with a sample slug in a first position;

FIG. 3 illustrates the arrangement of FIG. 2 with the sample slug in a second position;

FIG. 4 illustrates an arrangement of a focus tracking module and a second implementation of a flow cell in the system of FIG. 1 with sample slugs in first positions;

FIG. 5 illustrates the arrangement of FIG. 4 with the sample slugs in second positions;

FIG. 6 illustrates a flowchart for a method of loading a sample slug of a sample of interest into a flow cell using system of FIG. 1 or any of the disclosed implementations;

FIG. 7 depicts a schematic view of an example of a system that may be used to provide biological or chemical analysis;

FIG. 8 depicts a schematic view of an example of a set of components that may cooperate to provide a fluid path in the system of FIG. 7;

FIG. 9 depicts a schematic view of another example of a system that may be used to provide biological or chemical analysis;

FIG. 10 depicts a cross-sectional view of an example of a flow cell that may be used in the system of FIG. 7;

FIG. 11 depicts a cross-sectional view of another example of a flow cell that may be used in the system of FIG. 7;

FIG. 12 depicts a top plan view of the flow cell of FIG. 11, with an upper wafer omitted to reveal a lower wafer;

FIG. 13 depicts a schematic view of another example of a system that may be used to provide biological or chemical analysis;

FIG. 14 depicts a schematic view of an example of imaging components that may be integrated into the system of FIG. 13;

FIG. 15 depicts a schematic view of another example of imaging components that may be integrated into the system of FIG. 13;

FIG. 16 depicts a schematic view of another example of imaging components that may be integrated into the system of FIG. 13;

FIG. 17 depicts a schematic view of an example of a networked system in which the system of FIG. 7, 9, or 13 may be incorporated;

FIG. 18 depicts a schematic view of an example of a base calling arrangement that may be carried out using the system of FIG. 7, 9, 13, or 17;

FIG. 19 depicts a graph showing examples of Gaussian clouds representing a probabilistic distribution of base-wise intensity outputs of the bases during a sequencing operation using the system of FIG. 7, 9, 13, or 17;

FIG. 20 depicts a schematic view of an example of a base caller training technique that may be implemented using the system of FIG. 7, 9, 13, or 17;

FIG. 21 depicts a schematic view of an example of a structural variation graph genome that may be generated using the system of FIG. 7, 9, 13, or 17; and

FIG. 22 depicts a schematic view of an example of nucleotide read alignments that may be provided based on the structural variation graph genome of FIG. 21.

### DETAILED DESCRIPTION

Although the following text discloses a detailed description of implementations of methods, systems and/or articles of manufacture, it should be understood that the legal scope of the property right is defined by the words of the claims set forth at the end of this patent. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

When loading a sample of interest onto a flow cell of a sequencing platform system, placement accuracy of the sample of interest within the flow cell is key, as the quantity of DNA available in a sample of interest is frequently limited. However, typical sample loading procedures in this workflow are done “blind” and there is no way to determine where the sample of interest ultimately ends up and whether or not it is accurately located within the flow cell.

The disclosed implementations relate to increasing the accuracy of delivering samples of interest to an active area of a flow cell, which can enable less sample volume to be used. For example, the disclosed implementations may enable between about 10% and about 30% less sample volume to be used when seeding a flow cell.

In some implementations, a sample loading manifold assembly and a pump flow a sample slug of a sample of interest into a channel of a flow cell. The sample slug is enclosed by air slugs on either side of the sample slug, which can reduce the diffusion of the sample slug and the surrounding reagent (i.e., a buffer). Meniscuses are formed at the interfaces between the reagent and the air slugs at each side of the sample slug. A focus tracking module of an optical assembly can detect at least one of the meniscuses within the channel of the flow cell (e.g., at the leading edge of the sample slug) and the system can determine the position of the sample slug based on the position of the meniscus. The focus tracking module can use the differential reflectivity of the air slugs versus the reagent to locate the meniscus between the air slug and the reagent as the air slug enters the channel of the flow cell and thus provide feedback which can be used to more accurately place the sample slug on the active area of the flow cell. Based on the determined position of the sample slug, the pump can urge the sample slug over an active area of the flow cell based on the detected position of the meniscus. During the sequencing run, the focus tracking module of the optical assembly can also determine a z-position of a flow cell interface and the optical assembly may adjust the position of the objective based on the z-position determined. The objective may be adjusted to enable the optical assembly to be in focus. The focus tracking module may thus be used to enable the sample of interest to be accurately positioned on the flow cell and also to enable the optical assembly to be in focus.

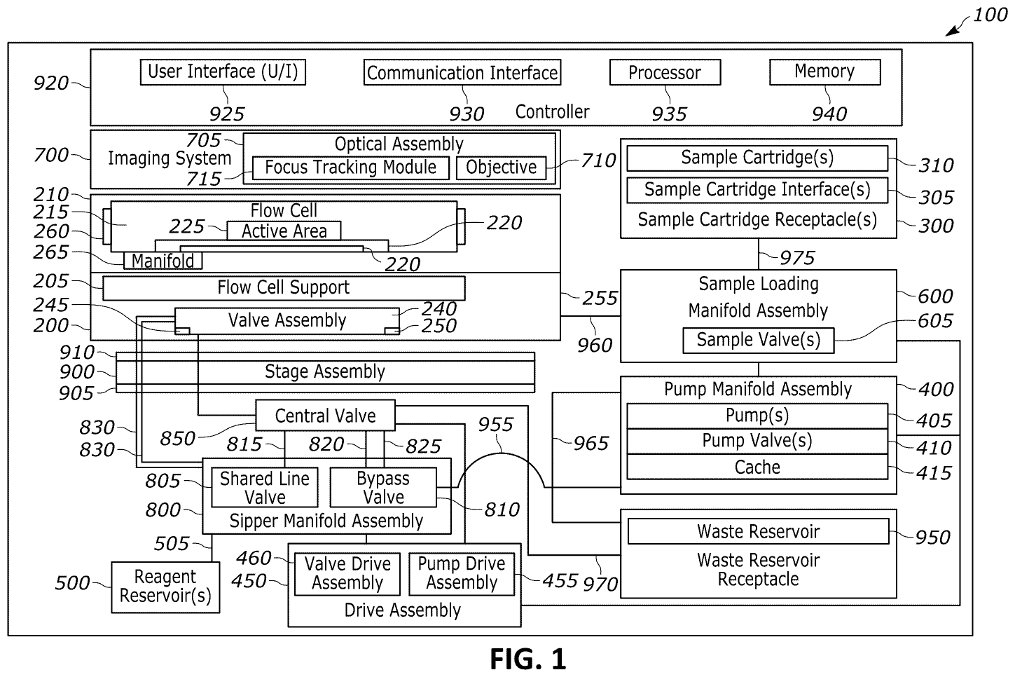

Referring to FIG. 1, a schematic diagram of an implementation of a system 100 in accordance with the teachings of this disclosure is illustrated. In some implementations, system 100 can be used to perform an analysis on one or more samples of interest, which in some implementations may include one or more DNA clusters that have been linearized to form a single stranded DNA (sstDNA). System 100 includes a flow cell interface 200 having a flow cell support 205 that is adapted to receive a flow cell assembly 210 including a corresponding flow cell 215 in the implementation shown. The flow cell interface 200 may be referred to as an interface. In some implementations, flow cell interface 200 can be any type of interface that is adapted to receive a substrate having an active area. Flow cell interface 200 may be associated with and/or referred to as a flow cell deck and flow cell support 205 may be associated with and/or referred to as a flow cell chuck. Flow cell support 205 can include a vacuum channel, latches, a snap fit mechanism, and/or a tongue-and-groove coupling that is used to secure flow cell assembly 210 to flow cell support 205. Flow cell interface 200 includes a flow cell deck 255 that carries flow cell support 205.

System 100 can also include, in part, an imaging system 700, a stage assembly 900, a reagent selector valve assembly 240 that has a reagent selector valve 245 and a valve drive assembly 250, and a controller 920. Reagent selector valve assembly 240 may be referred to as a mini-valve assembly. Controller 920 is electrically and/or communicatively coupled to components of system 100, such as imaging system 700, stage assembly 900, and reagent selector valve assembly 240, and is adapted to cause imaging system 700, stage assembly 900, and reagent selector valve assembly 240 to perform various functions as disclosed herein.

Stage assembly 900 includes an x-stage 905 and a y-stage 910. X-stage 905 moves flow cell interface 200 in an x-direction relative to imaging system 700 and y-stage 910 moves flow cell interface 200 in the y-direction relative to imaging system 700. X-stage 905 and/or y-stage 910 may be linear stages. X-stage 905 and/or y-stage 910 may be any type of motor or actuator. Stage assembly 900 can move the flow cell support 205 to different locations.

System 100 also includes a sipper manifold assembly 800, a sample loading manifold assembly 600, a pump manifold assembly 400, a drive assembly 450, and a waste reservoir 950 in the implementation shown. Controller 920 is electrically and/or communicatively coupled to sipper manifold assembly 800, sample loading manifold assembly 600, pump manifold assembly 400, and drive assembly 450 and is adapted to cause sipper manifold assembly 800, sample loading manifold assembly 600, pump manifold assembly 400, and drive assembly 450 to perform various functions as disclosed herein.

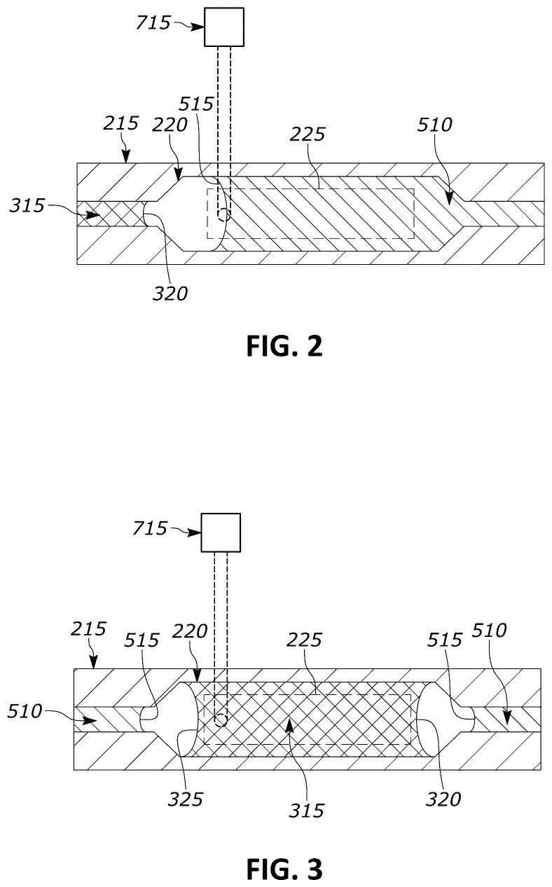

Referring to flow cell assembly 210, each flow cell 215 can include a channel 220 (or more than one channel as described below), each having a first channel opening positioned at a first end of flow cell 215 and a second channel opening positioned at a second end of flow cell 215. The flow cell 215 may be referred to as a substrate or a microfluidic device. Other substrates or microfluidic devices may alternatively be used in place of the flow cell 215 in some examples. Depending on the direction of flow through channel 220, either of the channel openings may act as an inlet or an outlet. While flow cell 215 is shown including one channel 220 in FIGS. 2-3, any number of channels may be included (e.g., 2 (FIGS. 1, 4-5), 6, 8, etc.). Each channel 220 includes an active area 225.

The flow cell assembly 210 also includes a flow cell frame 260 and a flow cell manifold 265 coupled to the first end of flow cell 215. As used herein, a “flow cell” (also referred to as a flowcell) can include a device having a lid extending over a reaction structure to form a flow channel therebetween that is in communication with a plurality of reaction sites of the reaction structure. Some flow cells may also include a detection device that detects designated reactions that occur at or proximate to the reaction sites. As shown, flow cell 215, flow cell manifold 265, and/or any associated gaskets used to establish a fluidic connection between flow cell 215 and system 100 are coupled or otherwise carried by flow cell frame 260. While flow cell frame 260 is shown included with flow cell assembly 210 of FIG. 1, flow cell frame 260 may be omitted. As such, flow cell 215 and the associated flow cell manifold 265 and/or gaskets may be used with system 100 without flow cell frame 260.

While some components of system 100 are shown once and coupled to a single flow cell 215, in some implementations, these components may be duplicated, thereby allowing more flow cells to be used with system 100 (e.g., 2, 3, 4, etc.) and each flow cell 215 can have its own corresponding components as a result. Each flow cell 215 may be associated with a separate sample cartridge 310, sample loading manifold assembly 600, pump manifold assembly 400, etc. when more than one flow cell 215 is included with the system 100.

Referring to the sample cartridge 310, sample loading manifold assembly 600, and pump manifold assembly 400, system 100 includes a sample cartridge receptacle 300 that receives sample cartridge 310 that carries and retains one or more samples of interest (e.g., an analyte). System 100 also includes a sample cartridge interface 305 that receives, and establishes a fluidic connection with sample cartridge 310. Sample cartridge interface 305 is fluidly coupled to sample loading manifold assembly 600 by a fluidic line 975. System 100 may alternatively be coupled to a library preparation system in some examples. Sample of interest may flow from the library preparation system into system 100. Sample cartridge receptacle 300, sample cartridge interface 305, and/or sample cartridge 310 may be omitted in such implementations.

Sample loading manifold assembly 600 includes one or more sample valve 605 and pump manifold assembly 400 includes one or more pump 405, one or more pump valve 410, and a cache 415. Sample valve 605 may be implemented by a rotary valve, a pinch valve, a flat valve, a solenoid valve, a check valve, a piezo valve, and/or a three-way valve. However, different types of fluid control devices may be used. Pump 405 may be implemented by a syringe pump, a peristaltic pump, and/or a diaphragm pump. Other types of fluid transfer devices may be used. System 100 may additionally or alternatively include a pump upstream of flow cell interface 200. The pump downstream of the flow cell interface 200 may be a positive pressure source. Cache 415 may be a serpentine cache and may temporarily store one or more reaction components during bypass manipulations of system 100. While cache 415 is shown being included in pump manifold assembly 400, in another implementation, cache 415 may be located in a different location. In certain implementations, cache 415 may be included in sipper manifold assembly 800 or in another manifold downstream of a bypass fluidic line 955.

Sample loading manifold assembly 600 and pump manifold assembly 400 flow one or more samples of interest from sample cartridge 310 through a fluidic line 960 toward flow cell assembly 210. In some implementations, the total length of fluidic line 975 and fluidic line 960 together can be greater than or equal to 1 meter and less than or equal to 3 meters and, in other implementations, is the total length can be approximately 2 meters. In some implementations, sample loading manifold assembly 600 can individually load/address each channel 220 of flow cell 215 with a sample of interest. The process of loading channel 220 of flow cell 215 with a sample of interest may occur automatically using system 100.

Sample cartridge 310 and sample loading manifold assembly 600 are positioned upstream of flow cell assembly 210 in system 100. Sample loading manifold assembly 600 may load a sample of interest into flow cell 215 from the rear of flow cell 215. Loading a sample of interest from the rear of flow cell 215 may be referred to as “back loading.” Back loading the sample of interest into flow cell 215 may reduce contamination. The sample loading manifold assembly 600 is coupled between flow cell assembly 210 and pump manifold assembly 400.

To draw a sample of interest from sample cartridge 310 and toward pump manifold assembly 400, sample valve 605, pump valve 410, and/or pump 405 may be selectively actuated to urge the sample of interest toward pump manifold assembly 400. Sample cartridge 310 may include a plurality of sample reservoirs that are selectively fluidically accessible via the corresponding sample valve 605. Each sample reservoir can thus be selectively isolated from other sample reservoirs using the corresponding sample valve 605.

To individually flow the sample of interest toward a corresponding channel of flow cell 215 and away from pump manifold assembly 400, sample valve 605, pump valve 410, and/or pump 405 can be selectively actuated to urge the sample of interest toward flow cell assembly 210 and into respective channel 220 of the corresponding flow cell 215. Channel 220 of flow cell 215 receives the sample of interest in some implementations. In other implementations, channel 220 of flow cell 215 selectively receives the sample of interest and others of channels of the flow cell, if the flow cell includes multiple channels, do not receive the sample of interest. Channel 220 of flow cell 215 that may not receive the sample of interest may receive a wash buffer instead.

Drive assembly 450 interfaces with sipper manifold assembly 800 and pump manifold assembly 400 to flow one or more reagents (i.e., buffers) that interact with the sample of interest within the corresponding flow cell 215. In an implementation, a reversible terminator is attached to the reagent to allow a single nucleotide to be incorporated onto a growing DNA strand. One or more of the nucleotides has a unique fluorescent label that emits a color when excited in some such implementations. The color (or absence thereof) is used to detect the corresponding nucleotide. Imaging system 700 excites one or more of the identifiable labels (e.g., a fluorescent label) in the implementation shown and thereafter obtains image data for the identifiable labels. The labels may be excited by incident light and/or a laser and the image data may include one or more colors emitted by the respective labels in response to the excitation. The image data (e.g., detection data) may be analyzed by system 100. Imaging system 700 may be a fluorescence spectrophotometer including an objective lens and/or a solid-state imaging device. The solid-state imaging device may include a charge coupled device (CCD) and/or a complementary metal oxide semiconductor (CMOS). Other types of imaging systems and/or optical instruments may be used. Imaging system 700 may be or may be associated with a scanning electron microscope, a transmission electron microscope, an imaging flow cytometer, high-resolution optical microscopy, confocal microscopy, epifluorescence microscopy, two photon microscopy, differential interference contrast microscopy, etc. in certain implementations. Imaging system 700 can also include an optical assembly 705 having an objective 710 for light gathering and image formation and a sensor, which in the implementation shown is a focus tracking module 715 configured to maintain focus of imaging system 700. Focus tracking module 715 can be configured to determine a z-position of flow cell interface 200 (a height of focus tracking module 715 above flow cell interface 200) and optical assembly 705 can be configured to adjust a position of objective 710 based on the z-position determined by focus tracking module 715. In other implementations, the sensor could be other types of touchless sensors, such as an ultrasonic sensor, an optical sensor, a thermal sensor, a radar sensor, and/or an infrared sensor.

After the image data is obtained, drive assembly 450 interfaces with sipper manifold assembly 800 and pump manifold assembly 400 to flow another reaction component (e.g., a reagent) through flow cell 215 that is thereafter received by waste reservoir 950 via a primary waste fluidic line 965 and/or otherwise exhausted by system 100. Some reaction components perform a flushing operation that chemically cleaves the fluorescent label and the reversible terminator from the sstDNA. The sstDNA is then ready for another cycle.

The primary waste fluidic line 965 is coupled between pump manifold assembly 400 and waste reservoir 950. Pump 405 and/or pump valve 410 of pump manifold assembly 400 selectively flow the reaction components from flow cell assembly 210, through fluidic line 960 and sample loading manifold assembly 600 to primary waste fluidic line 965 in some implementations.

Flow cell assembly 210 is coupled to a central valve 850 via flow cell interface 200. An auxiliary waste fluidic line 970 is coupled to central valve 850 and to waste reservoir 950. Auxiliary waste fluidic line 970 receives excess fluid of a sample of interest from flow cell assembly 210 in some implementations, via central valve 850, and flows the excess fluid of the sample of interest to waste reservoir 950 when back loading the sample of interest into flow cell 215, as described herein. That is, the sample of interest may be loaded from the rear of flow cell 215 and any excess fluid for the sample of interest may exit from the front of flow cell 215. By back loading samples of interest into flow cell 215, different samples can be separately loaded to corresponding channels, if multiple channels are included, of the corresponding flow cell and flow cell manifold 265 can couple the front of the flow cell to central valve 850 to direct excess fluid of each sample of interest to auxiliary waste fluidic line 970. Once the samples of interest are loaded into flow cell 215, flow cell manifold 265 can be used to deliver common reagents from the front of flow cell 215 (e.g., upstream) for each channel 220 of flow cell 215 that exit from the rear of flow cell 215 (e.g., downstream). Put another way, the sample of interest and the reagents may flow in opposite directions through the channel 220 of flow cell 215.

Sipper manifold assembly 800 includes a shared line valve 805 and a bypass valve 810 in the implementation shown. Shared line valve 805 may be referred to as a reagent selector valve. Reagent selector valve 245 of reagent selector valve assembly 240, central valve 850, and/or shared line valve 805, bypass valve 810 of sipper manifold assembly 800 may be selectively actuated to control the flow of fluid through bypass fluidic line 955, shared reagent fluidic line 815, reagent fluidic line 820, reagent fluidic line 825, and dedicated reagent fluidic lines 830. One or more of reagent selector valve 245, sample valve 605, pump valve 410, central valve 850, shared line valve 805 may be implemented by a rotary valve, a pinch valve, a flat valve, a solenoid valve, a check valve, a piezo valve, and/or a three-way valve. Other fluid control devices may prove suitable.

Sipper manifold assembly 800 may be coupled to a corresponding number of reagent reservoirs 500 via reagent sippers 505. Reagent reservoirs 500 may contain fluid (e.g., reagent and/or another reaction component). Sipper manifold assembly 800 includes a plurality of ports in some implementations. Each port of sipper manifold assembly 800 may receive one of reagent sippers 505. Reagent sippers 505 may be referred to as fluidic lines. While system 100 includes sipper manifold assembly 800, system 100 may alternatively receive a reagent cartridge and, thus, sipper manifold assembly 800 may be modified to omit reagent sippers 505 and/or to include an alternative fluidic interface, for example, or sipper manifold assembly 800 may be omitted. Pump 405 is configured to flow a reagent 510 (i.e., a buffer) from reagent reservoirs 500 into channel 220 of flow cell 215 and to flow a sample slug 315 of a sample of interest through sample loading manifold assembly 600 into channel 220 of flow cell 215. Sample slug 315 can have a volume that is greater than or equal to 100 microliters and less than or equal to 200 microliters and, in some implementations, is approximately 150 microliters. In the implementation shown, pump 405 can be configured to push sample slug 315 into channel 220 of flow cell 215. Pump 405 may alternatively be configured to pull the sample over the flow cell 215. Multiple pumps 405 may be used as another alternative, where one pump pushes the sample slug 315 into the channel 220 and another pump is used to accurately position the sample slug 315 over the active area 225.

Shared line valve 805 of sipper manifold assembly 800 is coupled to central valve 850 via shared reagent fluidic line 815. Different reagents may flow through shared reagent fluidic line 815 at different times. In an implementation, pump manifold assembly 400 may draw wash buffer through shared reagent fluidic line 815, central valve 850, and the corresponding flow cell assembly 210 when performing a flushing operation before changing between one reagent and another. Shared reagent fluidic line 815 may, thus, be involved in the flushing operation. While one shared reagent fluidic line 815 is shown, any number of shared fluidic lines may be included in system 100.

Bypass valve 810 of sipper manifold assembly 800 is coupled to central valve 850 via reagent fluidic line 820, reagent fluidic line 825. Central valve 850 may have one or more ports that correspond to reagent fluidic line 820, reagent fluidic line 825.

Dedicated reagent fluidic lines 830 are coupled between sipper manifold assembly 800 and reagent selector valve assembly 240. Each dedicated reagent fluidic line 830 may be associated with a single reagent. The fluids that flow through dedicated reagent fluidic lines 830 may be used during sequencing operations and may include a cleave reagent, an incorporation reagent, a scan reagent, a cleave wash, and/or a wash buffer. Because only a single reagent may flow through each of dedicated reagent fluidic lines 830, dedicated reagent fluidic lines 830 themselves may not be flushed when performing a flushing operation before changing between one reagent and another. The approach of including dedicated reagent fluidic lines 830 may be helpful when system 100 uses reagents that may have adverse reactions with other reagents. Reducing a number of fluidic lines or a length of the fluidic lines that are flushed when changing between different reagents moreover reduces reagent consumption and flush volume and may decrease cycle times of system 100. While two dedicated reagent fluidic lines 830 are shown, any number of dedicated fluidic lines may be included in system 100.

Bypass valve 810 is also coupled to cache 415 of pump manifold assembly 400 via bypass fluidic line 955. One or more reagent priming operations, hydration operations, mixing operations, and/or transfer operations may be performed using bypass fluidic line 955. The priming operations, the hydration operations, the mixing operations, and/or the transfer operations may be performed independent of flow cell assembly 210. The operations using bypass fluidic line 955 may thus occur during incubation of one or more samples of interest within flow cell assembly 210. That is, shared line valve 805 can be utilized independently of bypass valve 810 such that bypass valve 810 can utilize bypass fluidic line 955 and/or cache 415 to perform one or more operations while shared line valve 805 and/or central valve 850 simultaneously, substantially simultaneously, or offset synchronously perform other operations. System 100 can thus perform multiple operations at once, thereby reducing run time.

In the implementation shown, drive assembly 450 includes a pump drive assembly 455 and a valve drive assembly 460. Pump drive assembly 455 may be adapted to interface with pump 405 to pump fluid through flow cell 215 and/or to load one or more samples of interest into flow cell 215. Valve drive assembly 460 may be adapted to interface with one or more of reagent selector valve 245, sample valve 605, pump valve 410, central valve 850, shared line valve 805, bypass valve 810 to control the position of the corresponding reagent selector valve 245, sample valve 605, pump valve 410, central valve 850, shared line valve 805, bypass valve 810.

In the implementation shown, controller 920 includes a user interface 925, a communication interface 930, one or more processor 935, and a memory 940 storing instructions executable by one or more processor 935 to perform various functions including the disclosed implementations. User interface 925, communication interface 930, and memory 940 are electrically and/or communicatively coupled to one or more processor 935.

In an implementation, user interface 925 can be adapted to receive input from a user and to provide information to the user associated with the operation of system 100 and/or an analysis taking place. User interface 925 may include a touch screen, a display, a keyboard, a speaker(s), a mouse, a track ball, and/or a voice recognition system. The touch screen and/or the display may display a graphical user interface (GUI).

In an implementation, communication interface 930 can be adapted to enable communication between system 100 and a remote system(s) (e.g., computers) via a network(s). The network(s) may include the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc. Some of the communications provided to the remote system may be associated with analysis results, imaging data, etc., generated or otherwise obtained by system 100. Some of the communications provided to system 100 may be associated with a fluidics analysis operation, patient records, and/or a protocol(s) to be executed by system 100.

One or more processor 935 and/or system 100 may include one or more of a processor-based system(s) or a microprocessor-based system(s). In some implementations, one or more processor 935 and/or system 100 includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

Memory 940 can include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache and/or any other storage device or storage disk in which information is stored for any duration (e.g., permanently, temporarily, for extended periods of time, for buffering, for caching).

Referring to FIGS. 2-3, an arrangement of focus tracking module 715 of optical assembly 705 of imaging system 700 and flow cell 215 is illustrated that can be used to configure system 100 to use focus tracking module 715 to accurately position sample slug 315 in active area 225 of channel 220 of flow cell 215. A first air slug 420 can be positioned on a first side 320 of sample slug 315, between sample slug 315 and reagent 510, and a second air slug 425 can be positioned on a second side 325 of sample slug 315, opposite first side 320, between sample slug 315 and reagent 510, which can minimize diffusion of sample slug 315 into reagent 510. For example, a sipper used to collect a sample slug of a sample of interest can be pulled out of the liquid for a short period of time to pull an air slug before and after the sample slug. Positioning first air slug 420 on first side 320 of sample slug 315 creates meniscus 515 (the interface between reagent 510 and first air slug 420) between reagent 510 and first air slug 420.

Focus tracking module 715 is configured to detect a position of meniscus 515 of reagent 510 between reagent 510 and sample slug 315, for example, with meniscus 515 within channel 220 of flow cell 215 (FIG. 2). The differential reflectivity of the liquid of reagent 510 and the gas of first air slug 420 as seen by focus tracking module 715 can be used to detect the location of meniscus 515. For example, a significant drop in reflected power received by focus tracking module 715 can be detected between the liquid of reagent 510 and the gas of first air slug 420. The reflected power of the beam of the focus tracking module is significantly higher when the reflected power is located over a spot that is filled with air.

Based on the position of meniscus 515, system 100 can determine the position of sample slug 315. For example, knowing the cross-sectional area and length of channel 220 of flow cell 215, the volume of first air slug 420, and the volume of sample slug 315, the position of sample slug 315 within channel 220 can be determined based on the position of meniscus 515 within channel 220 of flow cell 215.

Pump 405 is configured to flow sample slug 315 over active area 225 in channel 220 of flow cell 215 based on the position of meniscus 515. For example, system 100 can estimate the volume to pump to move sample slug 315 and place the sample slug 315 more accurately in active area 225 of channel 220 of flow cell 215 and pump 405 can be configured to pump the volume to move sample slug 315. In the implementation shown, pump 405 is configured to position sample slug 315 within active area 225 and position first air slug 420 and second air slug 425 outside of active area 225 of channel 220 of flow cell 215 (FIG. 3).

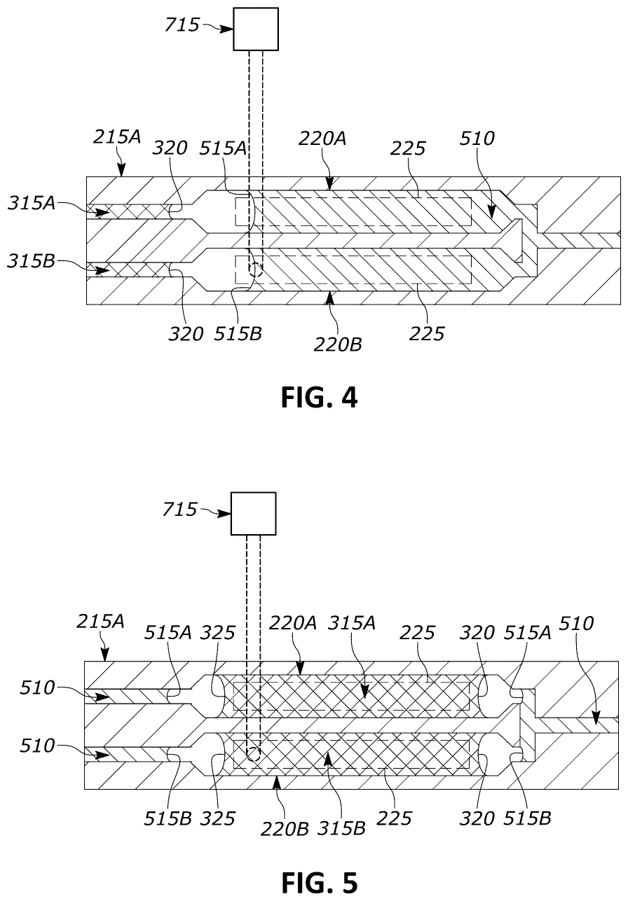

One or more flow cells of system 100 can also include a plurality of channels. In the implementation shown in FIG. 4-5, flow cell 215A includes a first channel 220A and a second channel 220B. In this implementation, a first air slug 420 can be positioned on a first side 320 of sample slug 315A and sample slug 315B and a second air slug 425 can be positioned on a second side 325 of sample slug 315A and sample slug 315B, opposite first side 320, between sample slug 315A and sample slug 315B and reagent 510. Positioning first air slug 420 on first side 320 of sample slug 315A and sample slug 315B creates first meniscus 515A between reagent 510 and first air slug 420 in front of sample slug 315A and second meniscus 515B between reagent 510 and first air slug 420 in front of sample slug 315B.

Focus tracking module 715 can be configured to sweep across first channel 220A and second channel 220B of flow cell 215A to detect the positions of first meniscus 515A in first channel 220A and second meniscus 515B in second channel 220B (FIG. 4). Thus, focus tracking module 715 can be moved and/or rastered in the x-direction while pumping is occurring in an attempt to monitor first channel 220A and second channel 220B at substantially the same time as an example. In other implementations, there can be multiple focus tracking modules, one for each channel of the flow cell. As described above, the differential reflectivity of the liquid of reagent 510 and the gas of first air slug 420 as seen by focus tracking module 715 can be used to detect the location of first meniscus 515A and second meniscus 515B, for example, by detecting a significant drop in reflected power received by focus tracking module 715 between the liquid of reagent 510 and the gas of first air slug 420.

Based on the position of first meniscus 515A and second meniscus 515B, system 100 can determine the position of sample slug 315A in first channel 220A and the position of sample slug 315B in second channel 220B. For example, knowing the cross-sectional area and length of first channel 220A and second channel 220B, the volume of first air slug(s) 420, and the volume of sample slug 315A and sample slug 315B, the position of sample slug 315A within first channel 220A and of sample slug 315B withing second channel 220B can be determined based on the position of first meniscus 515A within first channel 220A and the position of second meniscus 515B within second channel 220B.

Pump 405 is configured to flow sample slug 315A over active area 225 in first channel 220A based on the position of first meniscus 515A and to flow sample slug 315B over active area 225 in second channel 220B based on the position of second meniscus 515B. For example, system 100 can estimate the volume to pump to move sample slug 315A and place it as accurately as possible in active area 225 of first channel 220A and to move sample slug 315B and place it as accurately as possible in active area 225 of second channel 220B and pump 405 can be configured to pump the volume to move sample slug 315A and sample slug 315B. In the implementation shown, pump 405 is configured to position sample slug 315A within active area 225 of first channel 220A and sample slug 315B within active area 225 of second channel 220B, and position first air slug 420 and second air slug 425 outside of active area 225 of first channel 220A and second channel 220B (FIG. 5).

Many of the irregularities that can lead to inconsistent movement of the sample slug are expected to be due to physical features (e.g., tube length, pump diameters, etc.) that are expected to be fairly consistent over the life of an instrument. Therefore, the output of this workflow (e.g., the difference in meniscus position between lanes, the overall accuracy, etc.) could be measured and retained and then used to correct future loading events. This could be done as part of an instrument calibration process or it could be done adaptively as part of every loading event. In particular, channel-to-channel variation that are due to persistent physical features could be fairly easily corrected by estimating and then maintaining a different set of parameters for each channel (e.g., line length between sample wells and sample loading valves) that could be used to adjust pumping parameters.

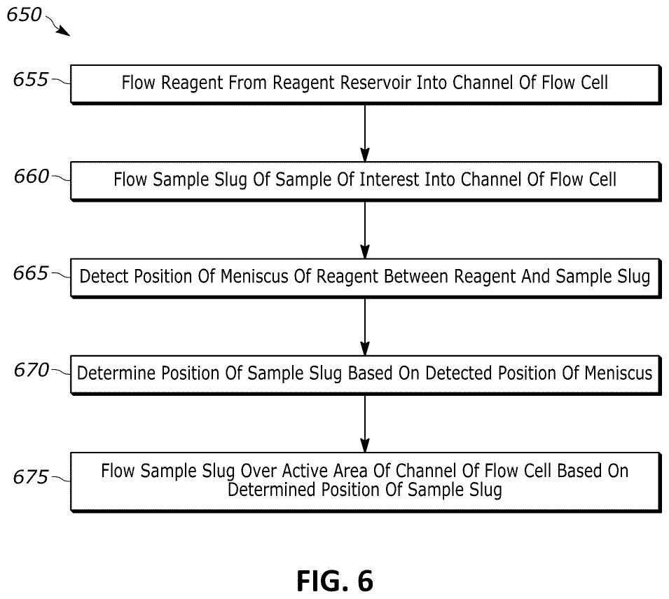

FIG. 6 illustrates a flowchart for a method 650 of loading a sample slug of a sample of interest into a flow cell using system 100 of FIG. 1, or any of the disclosed implementations. The order of execution of the blocks may be changed, and/or some of the blocks described may be changed, eliminated, combined, and/or subdivided into multiple blocks.

Method 650 of FIG. 6 begins with flowing reagent 510 from reagent reservoirs 500 into channel 220 of flow cell 215, in block 655. In the implementation of system 100 shown in FIG. 1, reagent 510 is flowed into channel 220 via pump 405.

For flow cell 215A with multiple channels, this process could include flowing reagent 510 from reagent reservoirs 500 into first channel 220A and into second channel 220B of flow cell 215A.

At block 660, sample slug 315 of the sample of interest is flowed from sample cartridge 310 through sample loading manifold assembly 600 into channel 220 of flow cell 215. In the implementation of system 100 shown in FIG. 1, sample slug 315 is pushed/pulled into channel 220 via pump 405. Sample cartridge 310 can be inserted into sample cartridge interface 305 and sample slug 315 can be flowed from sample cartridge interface 305 to sample loading manifold assembly 600 through fluidic line 975. In addition, to minimize diffusion of sample slug 315 into reagent 510, first air slug 420 can be positioned on first side 320 of sample slug 315 between sample slug 315 and reagent 510 and second air slug 425 can be positioned on second side 325 of sample slug 315, opposite first side 320, between sample slug 315 and reagent 510.

For flow cell 215A with multiple channels, this process could include flowing sample slug 315A of a first sample of interest from sample cartridge 310 through sample loading manifold assembly 600 into first channel 220A of flow cell 215A and flowing sample slug 315B of a second sample of interest from sample cartridge 310 through sample loading manifold assembly 600 into second channel 220B of flow cell 215A. In addition, first air slug 420 can be positioned on first side 320 of sample slug 315A and sample slug 315B between sample slug 315A and sample slug 315B and reagent 510 and second air slug 425 can be positioned on second side 325 of sample slug 315A and sample slug 315B, opposite first side 320, between sample slug 315A and sample slug 315B and reagent 510.

A position of meniscus 515 of reagent 510 between reagent 510 and sample slug 315 is detected at block 665. In implementation shown, meniscus 515 can be located between reagent 510 and first air slug 420. The position of meniscus 515 can be detected with focus tracking module 715 of imaging system 700 and can be detected within channel 220 of flow cell 215. The differential reflectivity of the liquid of reagent 510 and the gas of first air slug 420 as seen by focus tracking module 715 can be used to detect the location of meniscus 515. Meniscus 515 (the interface between reagent 510 and first air slug 420) can be detected by the significant drop in reflected power received by focus tracking module 715.

For flow cell 215A with multiple channels, this process could include sweeping focus tracking module 715 across first channel 220A and second channel 220B to detect a position of first meniscus 515A of reagent 510 between reagent 510 and sample slug 315A in first channel 220A and to detect a position of second meniscus 515B of reagent 510 between reagent 510 and sample slug 315B in second channel 220B.

Focus tracking module 715 can also determine the z-position of flow cell interface 200 and adjust the position of objective 710 of optical assembly 705 of imaging system 700 based on the z-position determined.

At block 670, the position of sample slug 315 is determined based on the detected position of meniscus 515. For example, knowing the cross-sectional area and length of channel 220 of flow cell 215, the volume of first air slug 420, and the volume of sample slug 315, the position of sample slug 315 within channel 220 can be determined based on the position of meniscus 515 (the interface between reagent 510 and first air slug 420) within channel 220 of flow cell 215.

For flow cell 215A with multiple channels, this process could include determining the position of sample slug 315A based on the detected position of first meniscus 515A and determining the position of sample slug 315B based on the detected position of second meniscus 515B.

Sample slug 315 is flowed over active area 225 of channel 220 of flow cell 215 based on the determined position of sample slug 315 at block 675. System 100 can estimate the required volume to pump to move sample slug 315 and place it as accurately as possible in active area 225 of channel 220 of flow cell 215. As shown in FIG. 3, sample slug 315 can be flowed over active area 225 such that first air slug 420 and second air slug 425 are outside of active area 225.

For flow cell 215A with multiple channels, this process could include flowing sample slug 315A over active area 225 of first channel 220A based on the determined position of sample slug 315A and flowing sample slug 315B over active area 225 of second channel 220B based on the determined position of sample slug 315B. Sample slug 315A and sample slug 315B can be flowed over active area 225 of first channel 220A and second channel 220B, respectively, such that first air slug 420 and second air slug 425 are outside of active area 225 of first channel 220A and second channel 220B.

### I. Overview of System for Biological or Chemical Analysis

Examples described herein may be used in various biological or chemical processes and systems for academic analysis, commercial analysis, or other analysis. More specifically, examples described herein may be used in various processes and systems where it is desired to detect an event, property, quality, or characteristic that is indicative of a designated reaction. Bioassay systems such as those described herein may be configured to perform a plurality of designated reactions that may be detected individually or collectively. For example, bioassay systems may be used to sequence a dense array of nucleic acid features through iterative cycles of enzymatic manipulation and image acquisition. In some examples, nucleic acids can be attached to a surface and amplified. Examples of such amplification are described in U.S. Pat. No. 7,741,463, entitled “Method of Preparing Libraries of Template Polynucleotides,” issued Jun. 22, 2010, the disclosure of which is incorporated by reference herein, in its entirety; and/or U.S. Pat. No. 7,270,981, entitled “Recombinase Polymerase Amplification,” issued Sep. 18, 2007, the disclosure of which is incorporated by reference herein, in its entirety.

Components that are used in the bioassay systems may include one or more microfluidic channels that deliver reagents or other reaction components to a reaction site. The reaction sites may be randomly distributed across a substantially planar surface; or may be patterned across a substantially planar surface. Each of the reaction sites may be imaged to detect light from the reaction site. The signals indicating photons emitted from the reaction sites and detected by image sensors may provide illumination values. These illumination values may be combined into an image indicating photons as detected from the reaction sites. These images may be further analyzed to identify compositions, reactions, conditions, etc., at each reaction site.

### II. Examples of Fluidics Devices and Fluid Flow Paths

### A. Example of System with Higher Volume Throughput

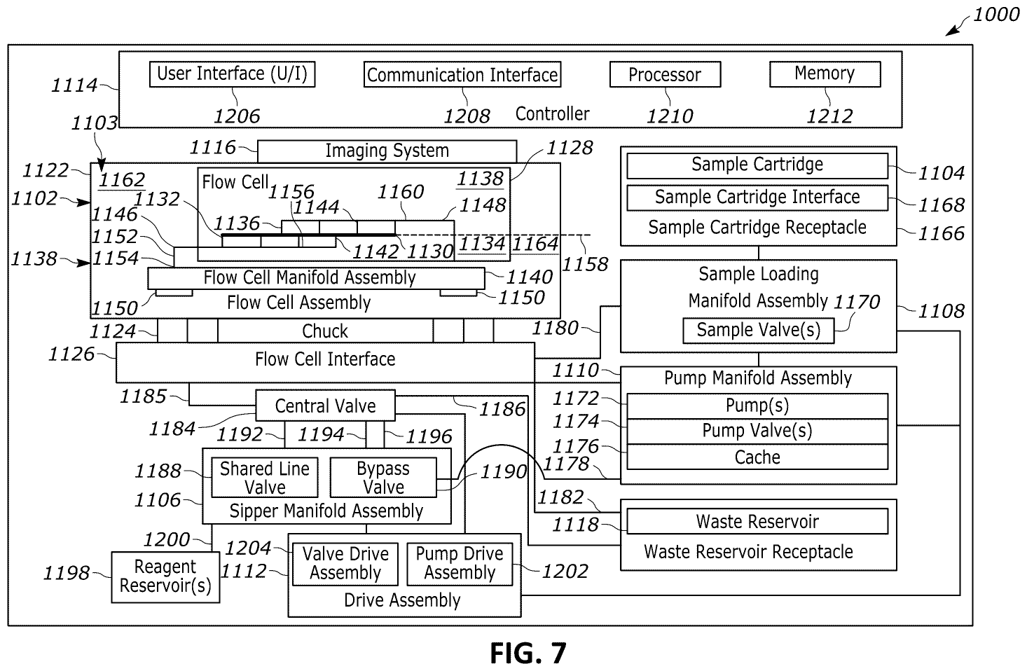

FIG. 7 illustrates a schematic diagram of an example of a system (1100) that may be used to perform an analysis on one or more samples of interest. In some implementations, the sample may include one or more clusters of nucleotides (e.g., DNA) that have been linearized to form a single stranded DNA (sstDNA). In the implementation shown, system (1100) is configured to receive a flow cell cartridge assembly (1102) including a flow cell assembly (1103) and a sample cartridge (1104). System (1100) includes a flow cell receptacle (1122) that receives flow cell cartridge assembly (1102), a vacuum chuck (1124) that supports flow cell assembly (1103), and a flow cell interface (1126) that is used to establish a fluidic coupling between system (1100) and flow cell assembly (1103). Flow cell interface (1126) may include one or more manifolds. System (1100) further includes a sipper manifold assembly (1106), a sample loading manifold assembly (1108), and a pump manifold assembly (1110). System (1100) also includes a drive assembly (1112), a controller (1114), an imaging system (1116), and a waste reservoir (1118). Controller (1114) is electrically and/or communicatively coupled to drive assembly (1112) and to imaging system (1116); and is configured to cause drive assembly (1112) and/or the imaging system (1116) to perform various functions as disclosed herein.

In the present example, flow cell assembly (1103) includes a flow cell (1128) having a channel (1130) and defining a plurality of first openings (1132), which are fluidically coupled to the channel (1130) and arranged on a first side (1134) of the channel (1130). Flow cell (1128) further includes a plurality of second openings (1136) fluidically coupled to the channel (1130) and arranged on a second side (1138) of the channel (1130). Fluid may thus flow through flow cell (1128) via channel. While the flow cell (1128) is shown including one channel (1130), flow cell (1128) may include two or more channels (1130). Flow cell assembly (1103) also includes a flow cell manifold assembly (1140) coupled to flow cell (1128) and having a first manifold fluidic line (1142) and a second manifold fluidic line (1144). Flow cell manifold assembly (1140) may be in the form of a laminate including a plurality of layers as discussed in more detail below.

In the implementation shown, first manifold fluidic line (1142) has a first fluidic line opening (1146) and is fluidically coupled to each of the first openings (1132) of flow cell (1128); and second manifold fluidic line (1144) has a second fluidic line opening (1148) and is fluidically coupled to each of the second openings (1136). As shown, flow cell assembly (1103) includes gaskets (1150) coupled to flow cell manifold assembly (1140) and fluidically coupled to fluidic line openings (1146, 1148). In some implementations where flow cell (1128) includes a plurality of channels (1130), flow cell manifold assembly (1140) may include additional fluidic lines (1152) that couple first fluidic line openings (1146) to a single manifold port (1154). In such implementations, a single gasket (1150) may be coupled to flow cell manifold assembly (1140) that surrounds the manifold port (1154) and is in fluidic communication with a plurality of channels (1130). In operation, flow cell interface (1126) engages with corresponding gaskets (1150) to establish a fluidic coupling between system (1100) and flow cell (1128). The engagement between flow cell interface (1126) and gaskets (1150) reduces or eliminates fluid leakage between flow cell interface (1126) and flow cell (1128).

In the implementation shown, first manifold fluidic line (1142) has a portion (1156) that is substantially parallel to a longitudinal axis (1158) of channel (1130); and second manifold fluidic line (1144) has a portion (1160) that is substantially parallel to longitudinal axis (1158) of channel (1130). Additionally, first manifold fluidic line (1142) is shown being at least partially adjacent a first end (1162) of flow cell (1128) and spaced from a second end (1164) of flow cell (1128); and second manifold fluidic line (1144) is shown being at least partially adjacent second end (1164) of flow cell (1128) and spaced from first end (1162). Other arrangements of manifold fluidic lines (1142, 1144) may prove suitable, however.

In the implementation shown, system (1100) includes a sample cartridge receptacle (1166) that receives sample cartridge (1104) that carries one or more samples of interest (e.g., an analyte). System (1100) also includes a sample cartridge interface (1168) that establishes a fluidic connection with sample cartridge (1104). Sample loading manifold assembly (1108) includes one or more sample valves (1170). Pump manifold assembly (1110) includes one or more pumps (1172), one or more pump valves (1174), and a cache (1176). Valves (1170, 1174) and pumps (1172) may take any suitable form. Cache (1176) may include a serpentine cache and may temporarily store one or more reaction components during, for example, bypass manipulations of the system (1100). While cache (1176) is shown being included in pump manifold assembly (1110), cache (1176) may alternatively be located elsewhere (e.g., in sipper manifold assembly (1106) or in another manifold downstream of a bypass fluidic line (1178), etc.).

Sample loading manifold assembly (1108) and pump manifold assembly (1110) flow one or more samples of interest from sample cartridge (1104) through a fluidic line (1180) toward flow cell cartridge assembly (1102). In some implementations, sample loading manifold assembly (1108) may individually load or address each channel (1130) of flow cell (1128) with a respective sample of interest. The process of loading channel (1130) with a sample of interest may occur automatically using system (1100). As shown in FIG. 7, sample cartridge (1104) and sample loading manifold assembly (1108) are positioned downstream of flow cell cartridge assembly (1102). In the implementation shown, sample loading manifold assembly (1108) is coupled between flow cell cartridge assembly (1102) and pump manifold assembly (1110). To draw a sample of interest from sample cartridge (1104) and toward pump manifold assembly (1110), sample valves (1170), pump valves (1174), and/or pumps (1172) may be selectively actuated to urge the sample of interest toward pump manifold assembly (1110). Sample cartridge (1104) may include a plurality of sample reservoirs that are selectively fluidically accessible via the corresponding sample valves (1170). To individually flow the sample of interest toward channel (1130) of flow cell (1128) and away from pump manifold assembly (1110), sample valves (1170), pump valves (1174), and/or pumps (1172) may be selectively actuated to urge the sample of interest toward flow cell cartridge assembly (1102) and into respective channels (1130) of flow cell (1128).

Drive assembly (1112) interfaces with sipper manifold assembly (1106) and pump manifold assembly (1110) to flow one or more reagents that interact with the sample within flow cell (1128). In some scenarios, a reversible terminator is attached to the reagent to allow a single nucleotide to be incorporated onto a growing DNA strand. In some such implementations, one or more of the nucleotides has a unique fluorescent label that emits a color when excited. The color (or absence thereof) is used to detect the corresponding nucleotide. In the implementation shown, imaging system (1116) excites one or more of the identifiable labels (e.g., a fluorescent label) and thereafter obtains image data for the identifiable labels. The labels may be excited by incident light and/or a laser and the image data may include one or more colors emitted by the respective labels in response to the excitation. The image data (e.g., detection data) may be analyzed by system (1100). Examples of features and functionalities that may be incorporated into imaging system (1116) will be described in greater detail below.

After the image data is obtained, drive assembly (1112) interfaces with sipper manifold assembly (1106) and pump manifold assembly (1110) to flow another reaction component (e.g., a reagent) through flow cell (1128) that is thereafter received by waste reservoir (1118) via a primary waste fluidic line (1182) and/or otherwise exhausted by system (1100). Some reaction components may perform a flushing operation that chemically cleaves the fluorescent label and the reversible terminator from the sstDNA. The sstDNA may then be ready for another cycle.

The primary waste fluidic line (1182) is coupled between pump manifold assembly (1110) and waste reservoir (1118). In some implementations, pumps (1172) and/or pump valves (1174) of pump manifold assembly (1110) selectively flow the reaction components from flow cell cartridge assembly (1102), through fluidic line (1180) and sample loading manifold assembly (1108) to primary waste fluidic line (1182). Flow cell cartridge assembly (1102) is coupled to a central valve (1184) via flow cell interface (1126). Central valve (1184) is coupled with flow cell interface (1126) via a fluidic line (1185). An auxiliary waste fluidic line (1186) is coupled to central valve (1184) and to waste reservoir (1118). In some implementations, auxiliary waste fluidic line (1186) receives excess fluid of a sample of interest from flow cell cartridge assembly (1102), via central valve (1184), and flows the excess fluid of the sample of interest to waste reservoir (1118) when back loading the sample of interest into flow cell (1128), as described herein.

Sipper manifold assembly (1106) includes a shared line valve (1188) and a bypass valve (1190). Shared line valve (1188) may be referred to as a reagent selector valve. Central valve (1184) and the valves (1188, 1190) of sipper manifold assembly (1106) may be selectively actuated to control the flow of fluid through fluidic lines (1192, 1194, 1196). Sipper manifold assembly (1106) may be coupled to a corresponding number of reagent reservoirs (1198) via reagent sippers (1200). Reagent reservoirs (1198) may contain fluid (e.g., reagent and/or another reaction component). In some implementations, sipper manifold assembly (1106) includes a plurality of ports. Each port of sipper manifold assembly (1106) may receive one of the reagent sippers (1200). Reagent sippers (1200) may be referred to as fluidic lines. Some forms of reagent sippers (1200) may include an array of sipper tubes extending downwardly along the z-dimension from ports in the body of sipper manifold assembly (1106). Reagent reservoirs (1198) may be provided in a cartridge, and the tubes of reagent sippers (1200) may be configured to be inserted into corresponding reagent reservoirs (1198) in the reagent cartridge so that liquid reagent may be drawn from each reagent reservoir (1198) into the sipper manifold assembly (1106).

Shared line valve (1188) of sipper manifold assembly (1106) is coupled to central valve (1184) via shared reagent fluidic line (1196). Different reagents may flow through shared reagent fluidic line (1196) at different times. In some versions, when performing a flushing operation before changing between one reagent and another, pump manifold assembly (1110) may draw wash buffer through shared reagent fluidic line (1196), central valve (1184), and flow cell cartridge assembly (1102).

Bypass valve (1190) of sipper manifold assembly (1106) is coupled to central valve (1184) via dedicated reagent fluidic lines (1194, 1196). Each of the dedicated reagent fluidic lines (1194, 1196) may be associated with a single reagent. The fluids that may flow through dedicated reagent fluidic lines (1194, 1196) may be used during sequencing operations and may include a cleave reagent, an incorporation reagent, a scan reagent, a cleave wash, and/or a wash buffer.

Bypass valve (1190) is also coupled to cache (1176) of pump manifold assembly (1110) via bypass fluidic line (1178). One or more reagent priming operations, hydration operations, mixing operations, and/or transfer operations may be performed using bypass fluidic line (1178). The priming operations, the hydration operations, the mixing operations, and/or the transfer operations may be performed independent of flow cell cartridge assembly (1102). Thus, the operations using bypass fluidic line (1178) may occur during, for example, incubation of one or more samples of interest within flow cell cartridge assembly (1102). That is, shared line valve (1188) may be utilized independently of bypass valve (1190) such that bypass valve (1190) may utilize bypass fluidic line (1178) and/or cache (1176) to perform one or more operations while shared line valve (1188) and/or central valve (1184) simultaneously, substantially simultaneously, or offset synchronously perform other operations.

Drive assembly (1112) includes a pump drive assembly (1202) and a valve drive assembly (1204). Pump drive assembly (1202) may be adapted to interface with one or more pumps (1172) to pump fluid through flow cell (1128) and/or to load one or more samples of interest into flow cell (1128). Valve drive assembly (1204) may be adapted to interface with one or more of the valves (1170, 1174, 1184, 1188, 1190) to control the position of the corresponding valves (1170, 1174, 1184, 1188, 1190).

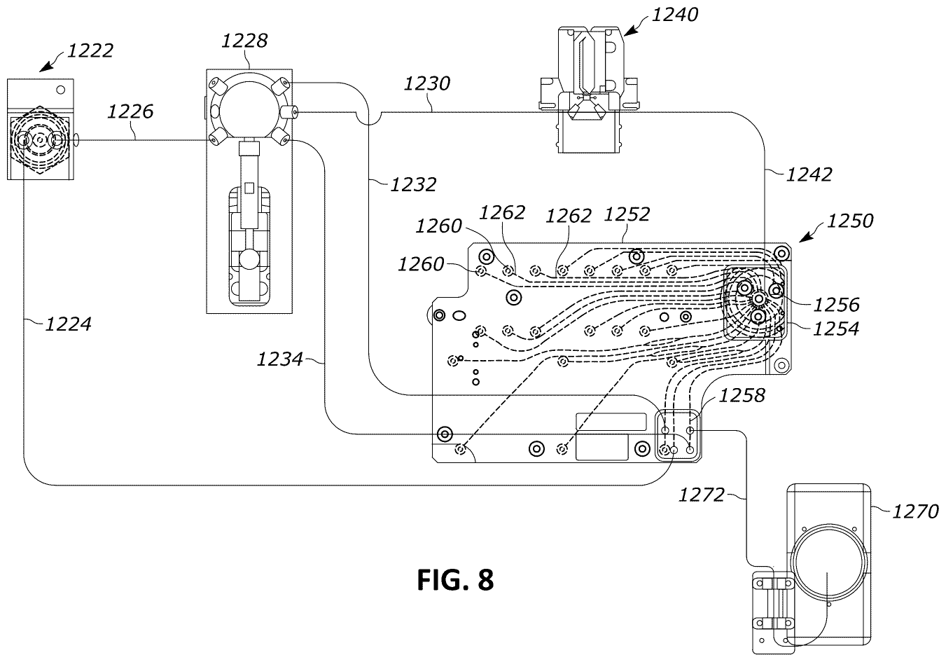

FIG. 8 shows an example of a fluidic arrangement (1220) that may be incorporated into a variation of system (1100). Fluidic arrangement (1220) of this example includes a pump manifold assembly (1222), which may operate similar to pump manifold assembly (1110) described above; a sample loading manifold assembly (1228), which may operate similar to sample loading manifold assembly (1108) described above; a flow cell interface (1240), which may operate similar to flow cell interface (1126) described above; a sipper manifold assembly (1250), which may operate similar to sipper manifold assembly (1106) described above; and a waste reservoir (1270), which may operate similar to waste reservoir (1118) described above. Pump manifold assembly (1222) is coupled with a port assembly (1258) of sipper manifold assembly (1250) via a fluidic line (1224), which may be similar to fluidic line (1178); and with sample loading manifold assembly (1228) via a fluidic line (1226). Sample loading manifold assembly (1228) is coupled with flow cell interface (1240) via fluidic line (1230), which may be similar to fluidic line (1180); and with port assembly (1258) via fluidic lines (1232, 1234). Flow cell interface (1240) is coupled with sipper manifold assembly (1250) via fluidic line (1242), which may be similar to fluidic line (1185). Sipper manifold assembly (1250) includes a manifold body (1252) and a common output port (1256), which provides fluid communication via fluidic line (1185). A valve assembly (1254) controls fluid flow through common output port (1256) and may operate similar to central valve (1184). Port assembly (1258) of sipper manifold assembly (1250) is coupled with waste reservoir (1270) via fluidic line (1272), which may be similar to fluidic line (1186).

A plurality of reagent sippers (1260) extend from manifold body (1252) and are fluidically coupled with valve assembly (1254) via respective fluid channels (1262) in manifold body (1252). Reagent sippers (1260) may operate similar to reagent sippers (1200). Valve assembly (1254) is operable to selectively couple fluid channels (1262) with flow cell interface (1240) via common output port (1256) and fluidic line (1230), to thereby selectively provide various reagents to flow cell interface (1240). In other words, when each reagent sipper (1260) is disposed in a different respective reagent (e.g., in a respective reagent reservoir (1198)), a flow cell (e.g., like flow cell (1128)) that is coupled with flow cell interface (1240) may selectively receive those different reagents based on control of valve assembly (1254).

Port assembly (1258) may provide a fluidic interface between pump manifold assembly (1222) and sipper manifold assembly (1250), thereby allowing sipper manifold assembly (1250) to receive pressurized fluid from pump manifold assembly (1222). Port assembly (1258) may also provide a fluidic interface between sample loading manifold assembly (1228) and sipper manifold assembly (1250), thereby allowing sipper manifold assembly (1250) to receive sample fluid from sample loading manifold assembly (1228). In addition, port assembly (1258) may provide a fluidic interface between waste reservoir (1270) and sipper manifold assembly (1250), thereby allowing sipper manifold assembly (1250) to communicate waste fluid to waste reservoir (1270). Communication of fluids via port assembly (1258) may be regulated, at least in part, by valve assembly (1254).

Referring back to FIG. 7, controller (1114) of the present example includes a user interface (1206), a communication interface (1208), one or more processors (1210), and a memory (1212) storing instructions executable by the one or more processors (1210) to perform various functions including the disclosed implementations. User interface (1206), communication interface (1133), and memory (1212) are electrically and/or communicatively coupled to the one or more processors (1210). User interface (1206) may be adapted to receive input from a user and to provide information to the user associated with the operation of system (1100) and/or an analysis taking place. User interface (1206) may include a touch screen, a display, a keyboard, a speaker(s), a mouse, a track ball, and/or a voice recognition system.

Communication interface (1208) is adapted to enable communication between system (1100) and a remote system(s) (e.g., computers) via a network(s) (e.g., the Internet, an intranet, a local-area network (LAN), a wide-area network (WAN), a coaxial-cable network, a wireless network, a wired network, a satellite network, a digital subscriber line (DSL) network, a cellular network, a Bluetooth connection, a near field communication (NFC) connection, etc.). Some of the communications provided to the remote system may be associated with analysis results, imaging data, etc. generated or otherwise obtained by system (1100). Some of the communications provided to system (1100) may be associated with a fluidics analysis operation, patient records, and/or a protocol(s) to be executed by system (1100).

The one or more processors (1210) and/or system (1100) may include one or more of a processor-based system(s) or a microprocessor-based system(s). In some implementations, the one or more processors (1210) and/or system (1100) includes one or more of a programmable processor, a programmable controller, a microprocessor, a microcontroller, a graphics processing unit (GPU), a digital signal processor (DSP), a reduced-instruction set computer (RISC), an application specific integrated circuit (ASIC), a field programmable gate array (FPGA), a field programmable logic device (FPLD), a logic circuit, and/or another logic-based device executing various functions including the ones described herein.

Memory (1212) may include one or more of a semiconductor memory, a magnetically readable memory, an optical memory, a hard disk drive (HDD), an optical storage drive, a solid-state storage device, a solid-state drive (SSD), a flash memory, a read-only memory (ROM), erasable programmable read-only memory (EPROM), electrically erasable programmable read-only memory (EEPROM), a random-access memory (RAM), a non-volatile RAM (NVRAM) memory, a compact disc (CD), a compact disc read-only memory (CD-ROM), a digital versatile disk (DVD), a Blu-ray disk, a redundant array of independent disks (RAID) system, a cache and/or any other storage device or storage disk in which information is stored for any duration (e.g., permanently, temporarily, for extended periods of time, for buffering, for caching).

### B. Example of System with Lower Volume Throughput

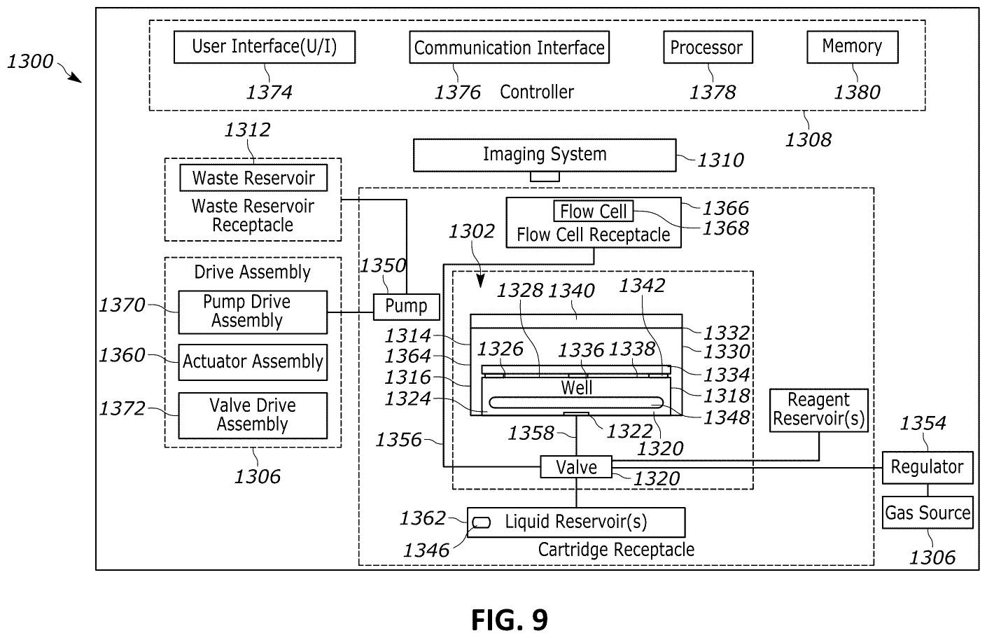

FIG. 9 illustrates a schematic diagram of another example of a system (1300) that may be used to perform an analysis on one or more samples of interest. Except as otherwise described below, system (1300) of this example may be configured and operable like system (1100) described above with reference to FIG. 7. In some instances, system (1100) is used to provide a higher volume throughput; while system (1300) is used to provide a lower volume throughput. Alternatively, systems (1100, 3100) may provide any other suitable amount or degree of throughput. System (1300) of the present example receives a reagent cartridge (1302) and includes, in part, a gas source (1304), a drive assembly (1306), a controller (1308), an imaging system (1310), and a waste reservoir (1312). Reagent cartridge (1302) may be referred to as a consumable, a reagent reservoir, or a reagent assembly. Controller (1308) is electrically and/or communicatively coupled to drive assembly (1306) and to imaging system (1310) and causes drive assembly (1306) and/or imaging system (1310) to perform various functions as disclosed herein.

Reagent cartridge (1302) in the implementation shown includes a well assembly (1314) having a body (1316). Body (1316) has a first wall (1318) defining a well (1320) having a port (1322). First wall (1318) has a distal end (1324) that defines an opening (1326) having an opening perimeter (1328). A second wall (1330) surrounds first wall (1318) and has a distal end (1332). Distal end (1332) may be referred to as an edge or an outer edge. A cover (1334) is coupled to distal end (1324) of first wall (1318) and covers opening (1326) along opening perimeter (1328) at a connected portion (1336); and is uncoupled from distal end (1324) of first wall (1318) at an unconnected portion (1338). Connection portion (1336) may be referred to as connection sections or connected segments and unconnected portion (1338) may be referred to as unconnected sections or unconnected segments. First wall (1318) has a height and second wall (1330) has a height that is greater than the height of first wall (1318). First wall (1318) and second wall (1330) may alternatively be the same or similar heights. An impermeable barrier (1340) is coupled to distal end (1332) of second wall (1330) and covers well (1320). Impermeable barrier (1340) may be foil, plastic, etc. and may prevent or inhibit moisture from infiltrating wells (1320) of reagent cartridge (1302).

Unconnected portion (1338) of cover (1334) forms a vent (1342) that allows air flow out of well (1320). Dried reagent (1348) is contained within well (1320), and vent (1342) is sized to substantially retain dried reagent (1348) within the well (1320). Body (1316) may include a plurality of wells (1320) while one well (1320) is shown in FIG. 9. Liquid (1346) may flow into well (1320) via port (1322) in practice to rehydrate dried reagent (1348). Vent (1342) may vent gas from well (1320) as liquid (1346) flows into well (1320); and cover (1334) prevents or inhibits reagent (1348) and/or liquid (1346) from escaping from well (1320). Put another way, vents (1342) retain reagent (1348) and/or liquid (1346) within wells (1320); and prevent or inhibit reagent (1348) and/or liquid (1346) from migrating out of wells (1320). Vent (1342) and cover (1334) prevent or inhibit cross-contamination between reagents when reagent cartridge (1302) includes more than one well (1320). Liquid (1346) and dried reagent (1348) may be flowed into and out of well (1320) to mix liquid (1346) from liquid reservoir (1362) and dried reagent (1348). System (1300) and/or reagent cartridge (1302) may include a mixing chamber that is used to mix liquid (1346) and dried reagent (1348) in some implementations. Impermeable barrier (1340) may be pierced prior to liquid (1346) flowing into well (1320).

Gas source (1304) may be used to pressurize liquid reservoir (1362) to flow liquid (1346) into well (1320); and/or a pump (1350) may draw liquid (1346) from liquid reservoir (1362) and flow liquid (1346) into well (1320) to rehydrate reagent (1348). Gas source (1304) may be provided by system (1300) and/or may be carried by reagent cartridge (1302). Gas source (1304) may alternatively be omitted. Pump (1350) may be implemented by a syringe pump, a peristaltic pump, a diaphragm pump, etc. While pump (1350) may be positioned downstream of flow cell (1368) as shown, pump (1350) may be positioned upstream of flow cell (1368) or omitted entirely.

Reagent cartridge (1302) and/or system (1300) includes valves (1352) that may be selectively actuatable to control the flow of fluid through fluidic lines (1356). Such valves (1352) may be implemented by a valve manifold, a rotary valve, a selector valve, a pinch valve, a flat valve, a solenoid valve, a check valve, a piezo valve, etc. A regulator (1354) may be positioned between gas source (1304) and valve (1352); and regulate the pressure of the gas provided to valve (1352). Regulator (1354) may include a valve that controls the flow of the gas from gas source (1304).

Body (1316) of well assembly (1314) has an edge (1364); and impermeable barrier (1340) may be hermetically connected to body (1316) along edge (1364). Impermeable barrier (1340) may include foil, plastic, and/or any other suitable material(s). System (1300) may pierce impermeable barrier (1340), impermeable barrier (1340) may be pierced by an individual prior to use, or impermeable barrier (1340) may be pierced by some other structure or methodology. System (1300) includes an actuator assembly (1360) in the implementation shown that interfaces with impermeable barrier (1340) to pierce impermeable barrier (1340). System (1300) may include a protrusion such as a post having a blunt or sharp end that is movable by actuator assembly (1360) to pierce impermeable barrier (1340). Impermeable barrier (1340) may alternatively be pierced by an operator prior to reagent cartridge (1302) being positioned in system (1300). System (1300) also includes a liquid reservoir (1362) containing liquid (1346). Liquid (1346) may comprise a rehydrating liquid, a wash buffer, and/or any other suitable kind(s) of liquid.

System (1300) further includes a flow cell receptacle (1366) that receives a flow cell (1368). Flow cell (1368) may be configured and operable like flow cell (1128). In some variations, flow cell (1368) is carried by and/or integrated into reagent cartridge (1302). Flow cell (1368) may carry the sample of interest. Gas source (1304) and/or pump (1350) may flow liquid (1346) to rehydrate dry reagents (1348) and to flow one or more liquid reagents through reagent cartridge (1302) that interact with the sample. Imaging system (1310) may be configured and operable like imaging system (1116), such that imaging system (1310) may be used to obtain image data from flow cell (1368). After the image data is obtained, drive assembly (1306) may interface with reagent cartridge (1302) to flow another reaction component (e.g., a reagent) through flow cell (1368) that is thereafter received by the waste reservoir (1312) and/or otherwise exhausted by reagent cartridge (1302). In the present example, drive assembly (1306) includes a pump drive assembly (1370), a valve drive assembly (1372), and actuator assembly (1360). Pump drive assembly (1370) interfaces with pump (1350) to pump fluid through reagent cartridge (1302) and/or flow cell (1368); and valve drive assembly (1372) interfaces with valve (1352) to control the position of valve (1352).

Controller (1308) of this example includes a user interface (1374), a communication interface (1376), a processor (1378), and a memory (1380). User interface (1374) may be configured and operable like user interface (1206) of system (1100). Communication interface (1376) may be configured and operable like communication interface (1208) of system (1100). Processor (1378) may be configured and operable like processor (1210) of system (1100). Memory (1380) may be configured and operable like memory (1212) of system (1100).

Further examples and details of how various features of each system (1100, 1300) may be configured and operable will be described below. By way of further example only, the various features of system (1100, 1300) may be configured and operable in accordance with at least some of the teachings of U.S. Pat. App. No. 63/250,961, entitled “Flow Cells and Related Flow Cell Manifold Assemblies and Methods,” filed Sep. 30, 2021, the disclosure of which is incorporated by reference herein, in its entirety; U.S. Pat. No. 9,958,465, entitled “Detection Apparatus having a Microfluorometer, a Fluidic System, and a Flow Cell Latch Clamp Module,” issued May 1, 2018, the disclosure of which is incorporated by reference herein, in its entirety; and/or U.S. Pat. App. No. 63/325,462, entitled “Well Assemblies and Related Systems and Methods,” filed Mar. 30, 2022, the disclosure of which is incorporated by reference herein, in its entirety.

### III. Examples of Flow Cell Structures

As noted above, a system (1100, 1300) may execute reactions in a flow cell (1128, 1368) and/or perform analysis on one or more samples of interest in a flow cell (1128, 1368). The following describes examples of forms that such flow cells (1128, 1368) may take, it being understood that flow cells (1128, 1368) may take various other forms and have various other features in addition to or in lieu of the features described below.

### A. Example of Single-Surface Patterned Flow Cell

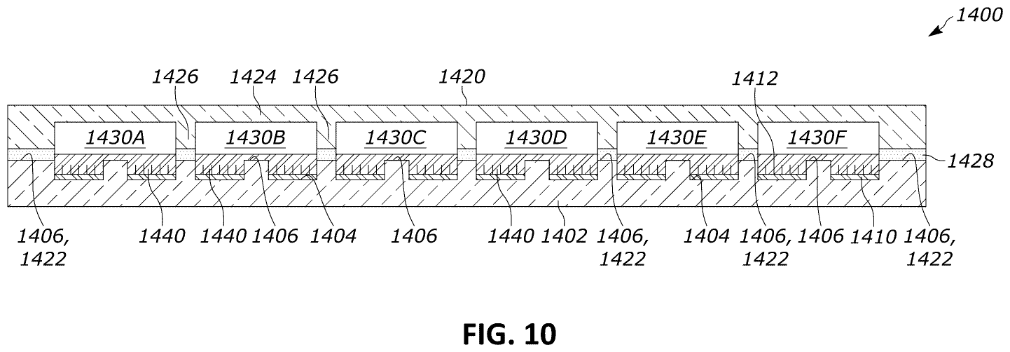

FIG. 10 shows an example of a flow cell (1400) that includes a patterned substrate (1402), which includes depressions (1404) separated by interstitial regions (1406), and surface chemistry (1410, 1412) positioned in the depressions (1404). Depressions (1404) may be in the form of microwells or nanowells. Depressions (1404) may be configured to contain nucleic acid strands or other oligonucleotides and thereby provide a reaction site for SBS and/or for other kinds of processes. In some versions, each depression (1404) has a cylindraceous configuration, with a generally circular cross-sectional profile. In some other versions, each depression (1404) has a polygonal (e.g., hexagonal, octagonal, square, rectangular, elliptical, etc.) cross-sectional profile. Alternatively, depressions (1404) may have any other suitable configuration. It should also be understood that depressions (1404) may be arranged in any suitable pattern, including but not limited to a grid pattern.

Surface chemistry (1410, 1412) of the present example includes functionalized coating layer (1410) and primers (1412). While not shown, it is to be understood that the depressions (1404) may also have surface preparation or treatment chemistry (e.g., silane or a silane derivative) positioned between the substrate (1402) and the functionalized coating layer (1410). This same surface preparation or treatment chemistry may also be positioned on the interstitial regions (1406). In the present example, a hydrogel (1440) is applied before lid (1420) is bonded to substrate (1402). Hydrogel (1440) covers surface chemistry (1410, 1412) in depressions (1404), and at least a portion of the patterned substrate (1402) (e.g., those interstitial regions (1406) that are not also bonding regions (1422)). By way of example only, hydrogel (1440) may comprise PAZAM, crosslinked polyacrylamide, agarose gel, etc.

Flow cell (1400) of this example further includes a lid (1420) bonded to bonding region(s) (1422) of patterned substrate (1402). In the example shown in FIG. 10, lid (1420) includes a top portion (1424) that is connected to several sidewalls (1426), and these components (1424, 1426) define a portion of each of the six flow channels (1430A, 1430B, 1430C, 1430D, 1430E, 1430F). The respective sidewalls (1426) isolate one flow channel (1430A, 1430B, 1430C, 1430D, 1430E, 1430F) from each adjacent flow channel (1430A, 1430B, 1430C, 1430D, 1430E, 1430F). Each flow channel (1430A, 1430B, 1430C, 1430D, 1430E, 1430F) is in selective fluid communication with a respective set of depressions (1404).

Lid (1420) may be bonded to bonding region (1422) of substrate (1402) using any suitable technique, such as laser bonding, diffusion bonding, anodic bonding, eutectic bonding, plasma activation bonding, glass frit bonding, or other methods known in the art. In some versions, a spacer layer (1428) may be used to bond lid (1420) to bonding region (1422). Spacer layer (1428) may comprise any material that will seal at least some of interstitial regions (1406) (e.g., bonding region (1422)) of substrate (1402) and lid (1420) together. While not shown, lid (1420) or the patterned substrate (1402) may include inlet and outlet ports that are to fluidically engage other ports (not shown), such as those of sample cartridge interface (1168), for directing fluid(s) into the respective flow channels (1430A, 1430B, 1430C, 1430D, 1430E, 1430F) (e.g., from a reagent cartridge or other fluid storage system) and out of the flow channel (e.g., to waste reservoir (1118) or another waste removal system). Flow channels (1430A, 1430B, 1430C, 1430D, 1430E, 1430F) may serve to, for example, selectively introduce reaction components or reactants to hydrogel (1440) and the underlying surface chemistry (1410, 1412) in order initiate designated reactions in/at depressions (1404).

While flow cell (1400) includes a pattern of depressions (1404) to provide an array of reaction sites, other variations may provide reaction sites on or at various other kinds of structural features, including but not limited to continuously planer surfaces and/or protruding surfaces, etc. By way of further example only, flow cell (1400) may be constructed and operable in accordance with at least some of the teachings of U.S. Pat. No. 10,919,033, entitled “Flow Cells with Hydrogel Coating,” issued Feb. 16, 2021, the disclosure of which is incorporated by reference herein, in its entirety.

### B. Example of Dual-Surface Patterned Flow Cell

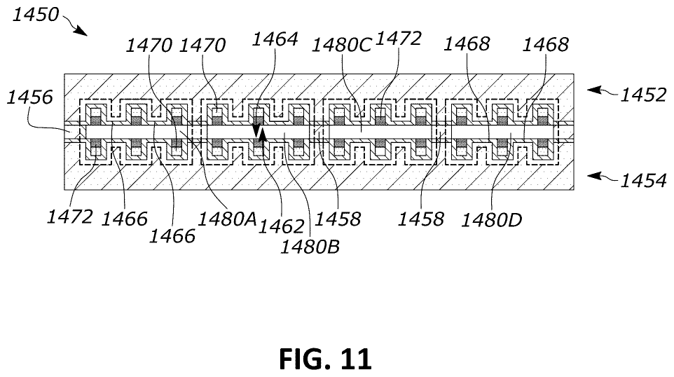

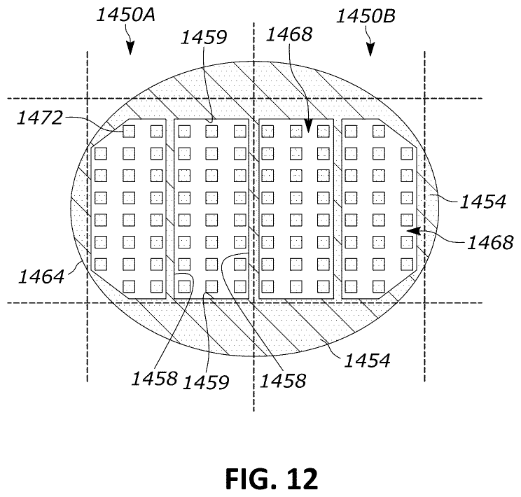

While FIG. 10 shows an example of a flow cell (1400) that has a single surface patterned with reaction sites (i.e., depressions (1404) formed in substrate (1402)), it may be desirable in some instances to provide a variation of flow cell (1400) that provide two surfaces patterned with reaction sites. An example of a dual-surface patterned flow cell (1450) is shown in FIGS. 11-12. In this example, flow cell (1450) includes a pair of wafers (1452, 1454) that are bonded together, with a spacer layer (1456) interposed between wafers (1452, 1454). Each wafer (1452, 1454) is patterned to provide a respective plurality of depressions (1462, 1464), such that depressions (1462) of wafer (1452) align with depressions (1464) of wafer (1454) when flow cell (1450) is assembled. Depressions (1462) are separated from each other by interstitial regions (1466); and depressions (1464) are separated from each other by interstitial regions (1468). Spacer layer (1456) does not contact interstitial regions (1466, 1468) in this example.

Depressions (1462, 1464) of flow cell (1450) may be configured and operable like depressions (1404) of flow cell (1400) described above. Each depression (1462, 1464) of the present example includes a grafted coating (1470), which may be similar to functionalized coating layer (1410); and primers (1472), which may be similar to primers (1412) described above. Each depression (1462, 1464) may further include hydrogel, like hydrogel (1440), and/or any other suitable feature(s). As shown in FIGS. 5-6, depressions (1462, 1464) are provided within a plurality of flow channels (1480A, 1480B, 1480C, 1480D). Flow channels (1480A, 1480B, 1480C, 1480D) are separated from each other by walls (1458) and ends (1459) formed by spacer layer (1456). In the example shown in FIG. 12, flow cell (1450) provides four flow channels (1480A, 1480B, 1480C, 1480D), with each flow channel (1480A, 1480B, 1480C, 1480D) containing several rows and columns of depressions (1462, 1464). When flow cell (1450) is used in system (1100, 1300), flow channels (1480A, 1480B, 1480C, 1480D) may serve to, for example, selectively introduce reaction components or reactants surface chemistry (1470, 1472) in order initiate designated reactions in/at depressions (1462, 1464). In some instances, since each wafer (1452, 1454) has its own set of depressions (1462, 1464) providing corresponding reaction sites, flow cell (1450) may provide twice as many reactions as a similarly sized flow cell (1400) during a given time period.

The broken lines in FIG. 12 indicate how flow cell (1450) may be diced to effectively form smaller flow cells (1450A, 1450A), with each smaller flow cell (1450A, 450A) having its own respective pair of flow channels (1480A, 1480B, 1480C, 1480D). In the present example, however, a single flow cell (1450) has more than two flow channels (1480A, 1480B, 1480C, 1480D). While flow cell (1450) includes a pattern of depressions (1462, 1464) to provide an array of reaction sites, other variations may provide reaction sites on or at various other kinds of structural features, including but not limited to continuously planer surfaces and/or protruding surfaces, etc. By way of further example only, flow cell (1450) may be constructed and operable in accordance with at least some of the teachings of U.S. Pat. No. 10,955,332, entitled “Flow Cell Package and Method for Making the Same,” issued Mar. 23, 2021, the disclosure of which is incorporated by reference herein, in its entirety.

### IV. Examples of Imaging System Features

As noted above, system (1100, 1300) includes an imaging system (1116, 1310) that excites one or more identifiable labels (e.g., a fluorescent label) in samples in reaction sites provided by depressions (1404, 1462, 1464) of a flow cell (1128, 1368, 1400, 1450); and thereafter obtains image data for the identifiable labels. This image data is used to identify nucleotides as part of a nucleic acid sequencing process. Alternatively, the image data may be used for various other purposes. The following description provides details on how some versions of imaging system (1116, 1310) may be configured and operable.

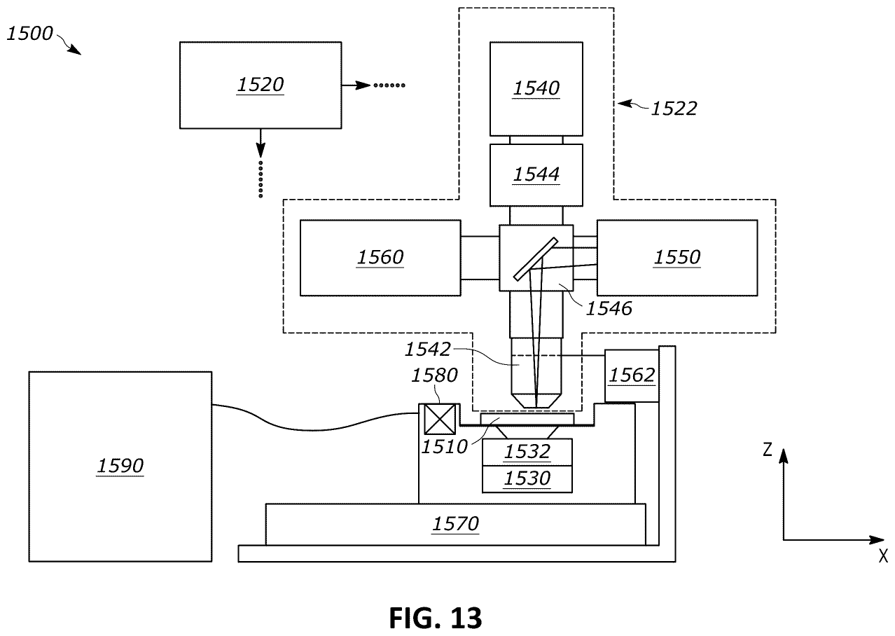

FIG. 13 illustrates a schematic diagram of another example of a system (1500) that may be used to perform an analysis on one or more samples of interest. Except as otherwise described below, system (1500) of this example may be configured and operable like systems (1100, 1300) described above. System (1500) is configured to perform a large number of parallel reactions within a flow cell (1510). Flow cell (1510) may be configured and operable like flow cells (1400, 1450) described above or may have any other suitable configuration. Flow cell (1510) may thus include one or more flow channels that receive a solution from system (1500) and direct the solution toward reaction sites of flow cell (1510).

System (1500) includes a system controller (1520) that may communicate with the various components, assemblies, and sub-systems of the system (1500). Controller (1520) may be configured and operable like controllers (1114, 1308) described above. An imaging assembly (1522) of system (1500) includes a light emitting assembly (1550) that emits light that reaches reaction sites on flow cell (1510). Light emitting assembly (1550) may include an incoherent light emitter (e.g., emit light beams output by one or more excitation diodes), or a coherent light emitter such as emitter of light output by one or more lasers or laser diodes. In some implementations, light emitting assembly (1550) may include a plurality of different light sources (not shown), each light source emitting light of a different wavelength range. Some versions of light emitting assembly (1550) may also include one or more collimating lenses (not shown), a light structuring optical assembly (not shown), a projection lens (not shown) that is operable to adjust a structured beam shape and path, epifluorescence microscopy components, and/or other components. Although system (1500) is illustrated as having a single light emitting assembly (1550), multiple light emitting assemblies (1550) may be included in some other implementations.

In the present example, the light from light emitting assembly (1550) is directed by dichroic mirror assembly (1546) through an objective lens assembly (1542) onto a sample of a flow cell (1510), which is positioned on a motion stage (1570). In the case of fluorescent microscopy of a sample, a fluorescent element associated with the sample of interest fluoresces in response to the excitation light, and the resultant light is collected by objective lens assembly (1542) and is directed to an image sensor of camera system (1540) to detect the emitted fluorescence. In some implementations, a tube lens assembly may be positioned between the objective lens assembly (1542) and the dichroic mirror assembly (1546) or between the dichroic mirror assembly (1546) and the image sensor of the camera system (1540). A moveable lens element may be translatable along a longitudinal axis of the tube lens assembly to account for focusing on an upper interior surface or lower interior surface of the flow cell (1510) and/or spherical aberration introduced by movement of the objective lens assembly (1542).

In the present example, a filter switching assembly (1544) is interposed between dichroic mirror assembly (1546) and camera system (1540). Filter switching assembly (1544) includes one or more emission filters that may be used to pass through particular ranges of emission wavelengths and block (or reflect) other ranges of emission wavelengths. For example, emission filters may be used to direct different wavelength ranges of emitted light to different image sensors of the camera system (1540) of imaging assembly (1522). For instance, the emission filters may be implemented as dichroic mirrors that direct emission light of different wavelengths from flow cell (1510) to different image sensors of camera system (1540). In some variations, a projection lens is interposed between filter switching assembly (1544) and camera system (1540). Filter switching assembly (1544) may be omitted in some versions.

System (1500) further includes a fluid delivery assembly (1590) that may direct the flow of reagents (e.g., fluorescently labeled nucleotides, buffers, enzymes, cleavage reagents, etc.) to (and through) flow cell (1510) and waste valve (1580). Fluid delivery assembly (1590) may be configured and operable like the various fluid delivery components described above in the context of FIGS. 7-9. System (1500) of the present example also includes a temperature station actuator (1530) and heater/cooler (1532) that may optionally regulate the temperature of conditions of the fluids within the flow cell (1510). In some implementations, the heater/cooler (1532) may be fixed to sample stage (1570), upon which the flow cell (1510) is placed, and/or may be integrated into sample stage (1570).

Flow cell (1510) may be removably mounted on sample stage (1570), which may provide movement and alignment of flow cell (1510) relative to objective lens assembly (1542). Sample stage (1570) may have one or more actuators to allow sample stage (1570) to move in any of three dimensions. For example, actuators may be provided to allow sample stage (1570) to move in the x, y, and z directions relative to objective lens assembly (1542), tilt relative to objective lens assembly (1542), and/or otherwise move relative to objective lens assembly (1542). Movement of sample stage (1570) may allow one or more sample locations on flow cell (1510) to be positioned in optical alignment with objective lens assembly (1542). Movement of sample stage (1570) relative to objective lens assembly (1542) may be achieved by moving sample stage (1570) itself, by moving objective lens assembly (1542), by moving some other component of imaging assembly (1522), by moving some other component of system (1500), or any combination of the foregoing. For instance, in some implementations, the sample stage (1570) may be actuatable in the x and y directions relative to the objective lens assembly (1542) while a focus component (1562) or z-stage may move the objective lens assembly (1542) along the z direction relative to the sample stage (1570).

In some implementations, a focus component (1562) may be included to control positioning of one or more elements of objective lens assembly (1542) relative to the flow cell (1510) in the focus direction (e.g., along the z-axis or z-dimension). Focus component (1562) may include one or more actuators physically coupled to the objective lens assembly (1542), the optical stage, the sample stage (1570), or a combination thereof, to move flow cell (1510) on sample stage (1570) relative to the objective lens assembly (1542) to provide proper focusing for the imaging operation. In the present example, the focus component (1562) utilizes a focus tracking module (1560) that is configured to detect a displacement of the objective lens assembly (1542) relative to a portion of the flow cell (1510) and output data indicative of an in-focus position to the focus component (1562) or a component thereof or operable to control the focus component (1562), such as controller (1520), to move the objective lens assembly (1542) to position the corresponding portion of the flow cell (1510) in focus of the objective lens assembly (1542).

In some implementations, an actuator of focus component (1562) or for sample stage (1570) may be physically coupled to objective lens assembly (1542), the optical stage, sample stage (1570), or a combination thereof, such as, for example, by mechanical, magnetic, fluidic, or other attachment or contact directly or indirectly to or with the stage or a component thereof. The actuator of focus component (1562) may be configured to move objective lens assembly (1542) in the z-direction while maintaining sample stage (1570) in the same plane (e.g., maintaining a level or horizontal attitude, perpendicular to the optical axis). In some implementations, sample stage (1570) includes an x direction actuator and a y direction actuator to form an x-y stage. Sample stage (1570) may also be configured to include one or more tip or tilt actuators to tip or tilt sample stage (1570) and/or a portion thereof, to account for any slope in its surfaces.

Camera system (1540) may include one or more image sensors to monitor and track the imaging (e.g., sequencing) of flow cell (1510). Camera system (1540) may be implemented, for example, as a CCD or CMOS image sensor camera, but other image sensor technologies (e.g., active pixel sensor) may be used. By way of further example only, camera system (1540) may include a dual-sensor time delay integration (TDI) camera, a single-sensor camera, a camera with one or more two-dimensional image sensors, and/or other kinds of camera technologies. While camera system (1540) and associated optical components are shown as being positioned above flow cell (1510) in FIG. 13, one or more image sensors or other camera components may be incorporated into system (1500) in numerous other ways as will be apparent to those skilled in the art in view of the teachings herein. For instance, one or more image sensors may be positioned under flow cell (1510), such as within the sample stage (1570) or below the sample stage (1570); or may even be integrated into flow cell (1510).

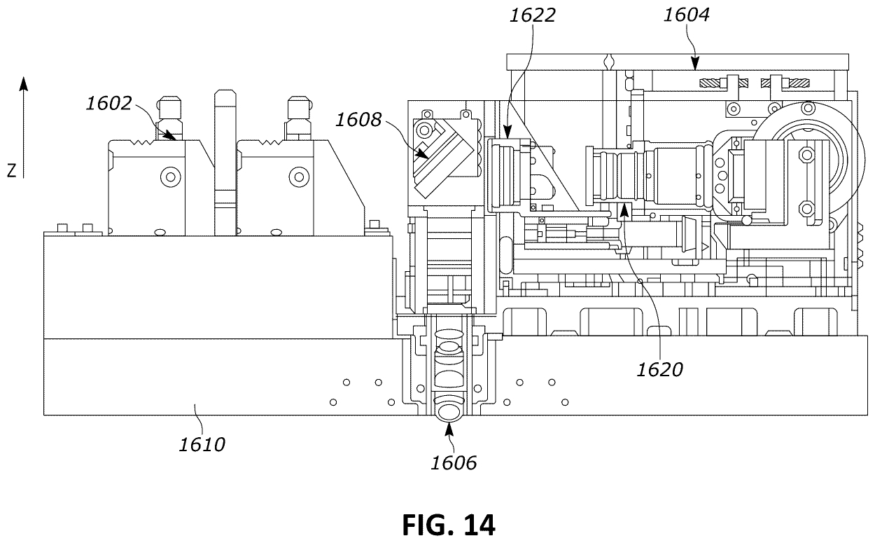

FIG. 14 shows an example of various components that may be integrated into imaging assembly (1522) of system (1500). In particular, the arrangement shown in FIG. 14 may represent a variation of light emitting assembly (1550). The arrangement shown in FIG. 14 may be particularly useful in scenarios where camera system (1540) includes a TDI camera. In the arrangement shown in FIG. 14, a line generation module (LGM) (1602) and emission optics module (EOM) (1604) are aligned and mechanically coupled to precision mounting plate (1610), as well as to each other. EOM (1604) includes an objective (1606) that is aligned, via a mirror (1608) with a tube lens (1620), which in turn is optically coupled to LGM (1602). LGM (1602) may include one or more light sources (e.g., coherent light sources such as laser diodes). In some examples, LGM (1602) may include a first light source configured to emit light in red wavelengths, and a second light source configured to emit light in green wavelengths. LGM (1602) may further include optical components, such as focusing surfaces, lenses, reflective surfaces, or mirrors. The optical components may be positioned within an enclosure of LGM (1602) to direct and focus the light emitted from the one or more light sources into an adjacent modular subassembly. One or more of the optical components of LGM (1602) may also be configured to shape the light emitted from the one or more light sources into desired patterns. For example, in some implementations, the optical components may shape the light into line patterns (e.g., by using one or more Powell lenses, or other beam shaping lenses, diffractive or scattering components). In some variations, LGM (1602) may include one or more laser modules which may be individually removed from LGM (1602) and replaced.

Light beams generated by LGM (1602) transmit through an interface baffle between LGM (1602) and EOM (1604), pass through objective (1606), and strike an optical target (e.g., flow cell (1510)). In some versions, the interface baffle includes an aperture shaped to enable light to pass through its center, while obscuring interference from external light sources. Responsive light radiation from the target may pass back through objective (1606) and into tube lens (1620). A lens element (1622), which may form part of tube lens (1620), is configured to articulate along an axis (e.g., a z-axis) to correct for spherical aberration artifacts introduced by objective (1606) imaging through varied thickness of flow cell (1510) components. As illustrated, lens element (1622) may be articulated closer to or further away from objective (1606) to adjust the beam shape and path. Objective (1606) may emit excitation light toward the optical target (e.g., flow cell (1510)) and receive fluorescence emission from the optical target. An actuator may be configured to position objective (1606) to a region of interest proximate to the optical target. The processor of controller (1520) may then execute program instructions for detecting fluorescence emission from the optical target.

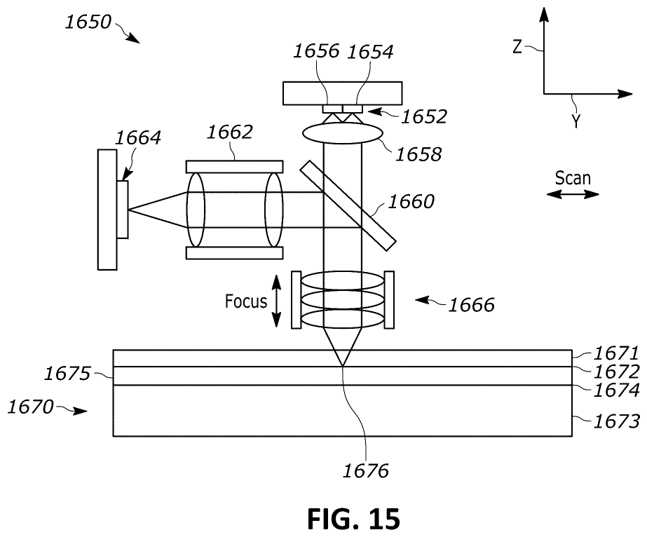

FIG. 15 shows an example of another configuration that may be provided in imaging assembly (1522). In particular, FIG. 15 shows an imaging assembly (1650) positioned in relation to a flow cell (1670). Flow cell (1670) may be representative of any of the variations of flow cells (1128, 1368, 1400, 1450, 1510) described herein. Flow cell (1670) has an upper layer (1671) and a lower layer (1673) that are separated by a fluid filled channel (1675). In the configuration shown, upper layer (1671) is optically transparent and imaging assembly (1650) is focused to an area (1676) on inner surface (1672) of upper layer (1671). In other variations, imaging assembly (1650) may be focused on inner surface (1674) of lower layer (1673). One or both of surfaces (1672, 1674) may include array features that are to be detected by imaging assembly (1650).

Imaging assembly (1650) includes an objective (1666) that is configured to direct excitation radiation from a radiation source (1652) to flow cell (1670); and to direct emission from flow cell (1670) to a detector (1664). In the arrangement shown, excitation radiation from radiation source (1652) passes through a lens (1658), though a beam splitter (1660), and through objective (1666) on to reach flow cell (1670). In the present example, radiation source (1652) includes two light emitting diodes (LEDs) (1656, 1654), which produce radiation at different wavelengths from each other. The emission radiation from flow cell (1670) is captured by objective (1666) and is reflected by beam splitter (1660) through conditioning optics (1662) and to detector (1664) (e.g., a CMOS sensor). Beam splitter (1660) functions to direct the emission radiation in a direction that is orthogonal to the path of the excitation radiation. The position of objective (1666) may be moved in the z dimension to alter focus of imaging assembly (1650). The imaging assembly (1650) may be moved back and forth in the y direction to capture images of several areas of at least one inner surface (1672, 1674) of flow cell (1670).

In the present example, a single imaging assembly (1650) includes two LEDs (1656, 1654) that emit light at two different respective wavelengths, with a single detector (1664) detecting light emitted from fluorophore labels in flow cell (1670) in response to irradiation at these two different wavelengths. In some other versions, there are two or more imaging assemblies (1650), with each imaging assembly (1650) including a single LED (1656, 1654) and a single detector (1664), such that each imaging assembly (1650) provides irradiation at only one single respective wavelength. As another variation, two or more detectors (1664) may receive excitation radiation from a common radiation source (1652).

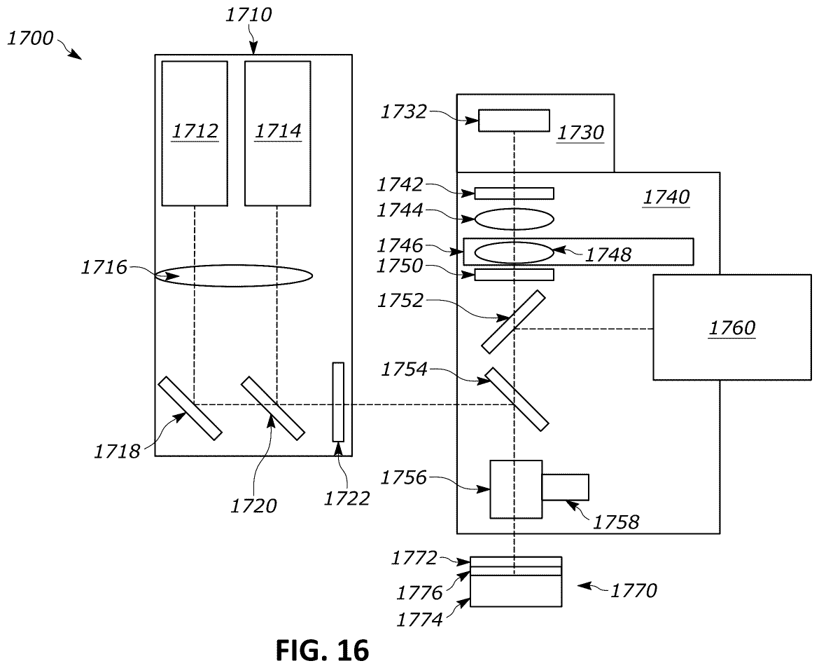

FIG. 16 shows an example of another configuration that may be provided in imaging assembly (1522). In particular, FIG. 16 shows an imaging assembly (1700) positioned in relation to a flow cell (1770). Flow cell (1770) may be representative of any of the variations of flow cells (1128, 368, 400, 450, 510) described herein. Flow cell (1770) has a translucent cover plate (1772), a substrate (1774), and a liquid layer (1776) that is interposed between cover plate (1772) and substrate (1774). A biological sample may be located on an inside surface of cover plate (1772) (above liquid layer (1776)) and/or on an inside surface of substrate (1774) (below liquid layer (1776)).

Imaging assembly (1700) of this example includes an LGM (1710) with two light sources (1712, 714), disposed therein. Light sources (1712, 1714) may include laser diodes, diode pumped solid state lasers, or other light sources as known in the art, which output laser beams at different wavelengths (e.g., red or green light). The light beams output from light sources (1712, 1714) are directed through a beam shaping lens or lenses (1716). In some implementations, one or more light shaping lenses may be used to shape the light beams output from each or both light sources. LGM (1710) may use one or more Powell lenses to spread and/or shape the laser beams from single or near-single mode laser light sources. Other beam shaping optics may be used to control uniformity and increase tolerance such as an active beam expander, an attenuator, one relay lenses, cylindrical lenses, actuated mirrors, diffractive elements, and scattering components. Laser beams may intersect at the back focal point of the objective lens to provide better tolerance on surfaces of flow cell (1770).

LGM (1710) of this example further includes mirrors (1718, 1720). A light beam generated by light source (1712) reflects off mirror (1718), as to be directed through an aperture or semi-reflective surface of mirror (1720), and into EOM (1740) through a single interface port. Similarly, a light beam generated by light source (1714) reflects off of mirror (1720) as to be directed into EOM (1740) through a single interface port. In some examples, an additional set of articulating mirrors may be incorporated adjacent to mirrors (1718, 1720) to provide additional tuning surfaces. Both light beams may be combined using dichroic mirror (1720). Mirrors (1718, 1720) may each be configured to articulate using manual or automated controls to align the light beams from light sources (1712, 1714). The light beams also pass through a shutter element (1722) in the present example.

EOM (1740) includes an objective (1756) and a z-stage (1758), which moves objective (1756) longitudinally closer to or further away from flow cell (1770). LGM (1710) is configured to generate a uniform line illumination through objective (1756). Z-stage (1758) may then move objective (1756) as to focus the light beams onto either of the inside surfaces of flow cell (1770) (e.g., focused on a biological sample). In some implementations, the objective (1756) may be configured to focus the light beams at a focal point beyond flow cell (1770), such as to increase the line width of the light beams at the surfaces of flow cell (1770).

EOM (1740) of the present example also include a semi-reflective mirror (1754) to direct light through objective (1756), while allowing light returned from flow cell (1770) to pass through. EOM (1740) further includes a tube lens (1744) and a corrective lens (1748). Corrective lens (1748) may be articulated longitudinally by a z-stage (1746), either closer to or further away from objective (1756), to ensure accurate imaging (e.g., to correct spherical aberration caused by moving objective (1756); and/or from imaging through a thicker substrate, etc.). Light transmitted through corrective lens (1748) and tube lens (1744) passes through filter element (1742) and into camera system (1730). Camera system (1730) includes one or more optical sensors (1732) to detect light emitted from the biological sample in response to the incident light beams.

In the present example, EOM (1740) further includes semi-reflective mirror (1752) to reflect a focus tracking light beam emitted from a focus tracking module (FTM) (1760) onto flow cell (1770), and then to reflect light returned from flow cell (1770) back into FTM (1760). FTM (1760) may include a focus tracking optical sensor to detect characteristics of the returned focus tracking light beam and generate a feedback signal to optimize focus of objective (1756) on flow cell (1770).

The direction, size, and/or polarization of the laser beams may be adjusted by using lenses, mirrors, and/or polarizers. Optical lenses (e.g., cylindrical, spherical, or aspheric) may be used to actively adjust the illumination focus on dual surfaces of the flow cell (1770) target. LGM (1710) may also include multiple units, with each unit being designed for particular/different wavelengths and polarization. Stacking multiple units may be used to increase the laser power and wavelength options. Two or more laser wavelengths may be combined with dichroics and polarizers.

By way of example only, focus tracking module (1560) and/or other components of imaging assembly (1522) may be constructed and operable in accordance with at least some of the teachings of U.S. Pat. No. 10,416,428, entitled “Systems and Methods for Improved Focus Tracking Using a Light Source Configuration,” issued Sep. 17, 2019, the disclosure of which is incorporated by reference herein, in its entirety; U.S. Pat. App. No. 63/300,531, entitled “Dynamic Detilt Focus Tracking,” filed Jan. 18, 2022, the disclosure of which is incorporated by reference herein, in its entirety; and/or U.S. Pat. App. No. 63/410,961, entitled “Spot Error Handling for Focus Tracking,” filed Sep. 28, 2022, the disclosure of which is incorporated by reference herein, in its entirety. By way of further example only, components of imaging assembly (1522) may be configured and operable in accordance with at least some of the teachings of U.S. Pat. No. 10,774,371, entitled “Laser Line Illuminator for High Throughput Sequencing,” issued Sep. 15, 2020, the disclosure of which is incorporated by reference herein, in its entirety; and/U.S. Pat. No. 9,958,465, entitled “Detection Apparatus having a Microfluorometer, a Fluidic System, and a Flow Cell Latch Clamp Module,” issued May 1, 2018, the disclosure of which is incorporated by reference herein, in its entirety.

### V. Examples of Data Processing Features

### A. Example of Networked Data Processing Arrangement

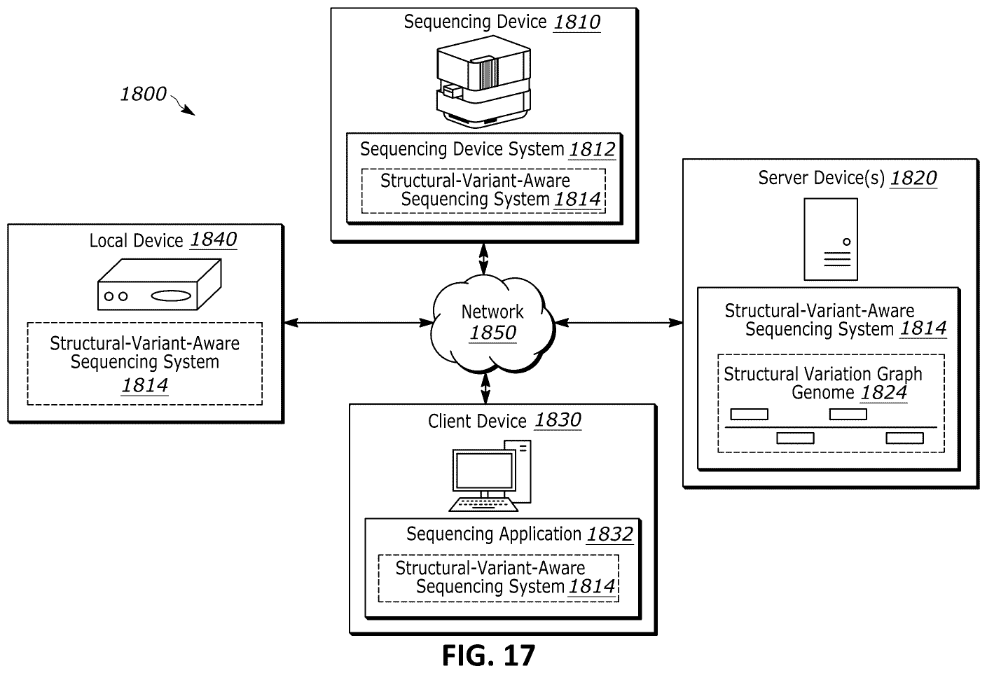

As noted above, a system (1100, 1300, 1500) may include a controller (1114, 1308, 1520) that is configured to process data, execute algorithms, etc., as needed to perform a sequencing operation or other kind of operation. In some scenarios, system (1100, 1300, 1500) may be coupled with other devices via a network to perform further data processing, data storage, execution of algorithms, etc. FIG. 17 shows an example of such an arrangement. In particular, FIG. 17 shows a networked system (1800) that includes a sequencing device (1810), a server device (1820), a client device (1830), and a local device (1840), with all devices (1810, 1820, 1830, 1840) being coupled together via a network (1850). Network (1850) may take any suitable form as will be apparent to those skilled in the art in view of the teachings herein.

As shown in FIG. 17, sequencing device (1810) comprises a computing device and a sequencing device system (1812) for sequencing a genomic sample or other nucleic-acid polymer. In some versions, by executing sequencing device system (1812) using a processor, sequencing device (1810) analyzes nucleotide fragments or oligonucleotides extracted from genomic samples to generate nucleotide reads or other data utilizing computer implemented methods and systems either directly or indirectly on sequencing device (1810). More particularly, sequencing device (1810) receives nucleotide-sample slides (e.g., flow cells (1128, 1368, 1400, 1450, 1510, 1670, 1770)) comprising nucleotide fragments extracted from samples and further copies and determines the nucleobase sequence of such extracted nucleotide fragments. It should be understood that sequencing device (1810) may represent a version of systems (1100, 1300, 1500) described above.

In some versions, the sequencing device (1810) utilizes SBS to sequence nucleotide fragments into nucleotide reads and determine nucleobase calls for the nucleotide reads. By executing sequencing device system (1812), sequencing device (1810) may further store the nucleobase calls as part of base-call data that is formatted as a binary base call (BCL) file and send the BCL file to the local device (1840) and/or the server device(s) (1820). Sequencing device (1810) may communicate the BCL file and/or other data to local device (1840) and/or client device (1830) via network (1850) or directly (i.e., bypassing network (1850)).

In some scenarios, local device (1840) is located at or near a same physical location of sequencing device (1810). For instance, local device (1840) and sequencing device (1810) may be integrated into a single computing device. Local device (1840) may run sequencing system (1814) to generate, receive, analyze, store, and transmit digital data, such as by receiving base-call data or determining variant calls based on analyzing such base-call data. By executing software in the form of sequencing system (1814), local device (1840) may align nucleotide reads with a structural variation graph genome (1824) and determine genetic variants based on the aligned nucleotide reads. Local device (1840) may also send data to client device (1830), including a variant call file (VCF) or other information indicating nucleobase calls, sequencing metrics, error data, or other metrics.

Server device(s) (1820) may be located remotely from the local device (1840) and sequencing device (1810). Server device(s) (1820) may comprise a distributed collection of servers, where server device(s) (1820) include a number of server devices distributed across network (1850) and located in the same or different physical locations. Similar to local device (1840), server device(s) (1820) may include a version of sequencing system (1814). Accordingly, server device(s) (1820) may generate, receive, analyze, store, and transmit digital data, such as by receiving base-call data or determining variant calls based on analyzing such base-call data. As indicated above, sequencing device (1810) may send (and server device(s) (1820) may receive) base-call data from sequencing device (1810). Server device(s) (1820) may also send data to client device (1830), including VCFs or other sequencing related information.

As indicated above, as part of server device(s) (1820) or local device (1840), sequencing system (1814) may generate or implement a structural variation graph genome with alternate contiguous sequences representing structural variant haplotypes. For instance, system (1814) may identify candidate structural variants of a threshold frequency (or that otherwise satisfy another occurrence threshold) within a genomic sample database. From among the candidate structural variants, sequencing system (1814) selects structural variant haplotypes based on one or both of satisfying another occurrence threshold and finding flanking variants adjacent to particular structural variant haplotypes. Sequencing system (1814) may likewise select reference haplotypes of genomic regions corresponding to the selected structural variant haplotypes from a reference genome. Based on the selected haplotypes, sequencing system (1814) generates a structural variation graph genome comprising both alternate contiguous sequences representing the structural variant haplotypes and reference sequences representing the reference haplotypes. Based on comparing nucleotide reads of a genomic sample with alternate contiguous sequences representing structural variant haplotypes, sequencing system (1814) can determine nucleobase calls for the genomic sample.

By executing a sequencing application (1832), client device (1830) may generate, store, receive, and send digital data. In particular, client device (1830) may receive sequencing data from local device (1840) or receive call files (e.g., BCL) and sequencing metrics from sequencing device (1810). Furthermore, client device (1830) may communicate with local device (1840) or server device(s) (1820) to receive a VCF comprising nucleobase calls and/or other metrics, such as a base-call-quality metrics or pass-filter metrics. Client device (1830) may accordingly present or display information pertaining to variant calls or other nucleobase calls within a graphical user interface of sequencing application (1832) to a user associated with client device (1830). For example, client device (1830) may present structural variant calls and/or sequencing metrics for a sequenced genomic sample within a graphical user interface of sequencing application (1832).

As shown in FIG. 17, sequencing application (1832) is included in client device (1830). Sequencing application (1832) may include a web application or a native application stored and executed on client device (1830) (e.g., a mobile application, desktop application). Sequencing application (1832) may include instructions that (when executed) cause client device (1830) to receive data from sequencing system (1814) and present, for display at client device (1830), base-call data or data from a VCF. Furthermore, sequencing application (1832) may instruct client device (1830) to display summaries for multiple sequencing runs.

As further illustrated in FIG. 17, a version of sequencing system (1814) may be located and implemented (e.g., entirely or in part) on client device (1830) or sequencing device (1810). In some versions, sequencing system (1814) is implemented by one or more other components of networked system (1800), such as local device (1840). In particular, sequencing system (1814) may be implemented in a variety of different ways across sequencing device (1810), local device (1840), server device(s) (1820), and client device (1830). For example, sequencing system (814) may be downloaded from server device(s) (1820) to sequencing system (1814) and/or local device (1840) where all or part of the functionality of sequencing system (1814) is performed at each respective device within networked system (1800).

### B. Examples of Base Calling Schemes

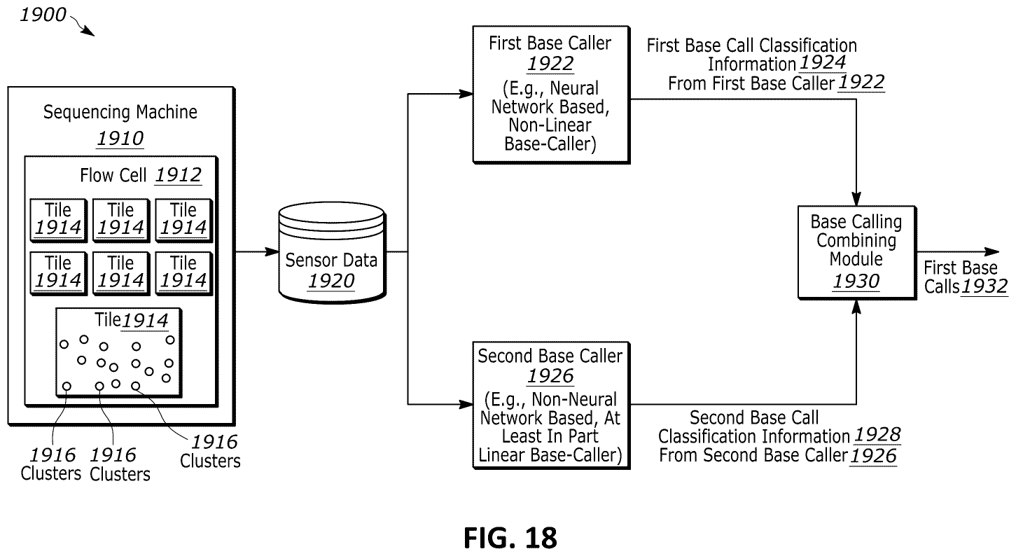

FIG. 18 illustrates a system (1900) that employs two or more base callers for base calling operations on the raw images (i.e., sensor data) output by image sensors in a sequencing machine sequencing machine (1910). Sequencing machine (1910) of this example includes a flow cell (1912), which includes a plurality of tiles (1914). Each tile (1914) includes a plurality of clusters (1916). Sequencing machine (1910) may be understood to represent a version of systems (1100, 1300, 1500) or sequencing device (1810) described above; while flow cell (1912) may be understood to represent a version of flow cells (1128, 1368, 1400, 1450, 1510, 1670, 1770) described above. Sequencing machine (1910) thus outputs sensor data (1920) comprising raw images from the tiles (1914) of flow cell (1912).

In the present example, system (1900) comprises a first base caller (1922) and a second base caller (1926), though some variations may include more than two base callers (1922, 1926). Each base caller (1922, 1926) of this example outputs corresponding base call classification information. For example, first base caller (1922) outputs first base call classification information (1924); and second base caller (1926) outputs second base call classification information (1928). A base calling combining module (1930) generates final base calls (1932), based on one or both first base call classification information (1924) and/or second base call classification information (1928). In some versions, first base caller (1922) is a neural-network based base-caller; while second base caller (1926) is a non-neural network based base-caller. For example, first base caller (1922) may include a non-linear system employing one or more neural network models for base calling. The first base caller (1922) may also be referred to as a DeepRTA (Deep Real Time Analysis) base caller or Deep Neural Network base caller.

By way of further example only, second base caller (1926) may include, at least in part, a linear system used for base calling. For example, some versions of second base caller (1926) do not employ a neural network for base calling (or use a smaller neural network model for base calling, compared to a larger neural network model used by first base caller (1922)). Second base caller (1926) may also be referred to as an RTA (Real Time Analysis) base caller. An RTA base caller may use linear intensity extractors to extract features from sequencing images for base calling. In some such versions, RTA performs a template generation step to produce a template image that identifies locations of clusters (1916) on a tile (1914) using sequencing images from some number of initial sequencing cycles called template cycles. The template image is used as a reference for subsequent registration and intensity extraction steps. The template image is generated by detecting and merging bright spots in each sequencing image of the template cycles, which in turn involves sharpening a sequencing image (e.g., using the Laplacian convolution), determining an “on” threshold by a spatially segregated Otsu approach, and subsequent five-pixel local maximum detection with subpixel location interpolation.

In another example, locations of clusters (1916) on a tile (1914) are identified using fiducial markers. A solid support upon which a biological specimen is imaged may include such fiducial markers, to facilitate determination of the orientation of the specimen or the image thereof in relation to probes that are attached to the solid support. Examples of fiducials include, but are not limited to, beads (with or without fluorescent moieties or moieties such as nucleic acids to which labeled probes can be bound), fluorescent molecules attached at known or determinable features, or structures that combine morphological shapes with fluorescent moieties.

RTA then registers a current sequencing image against the template image. This is achieved by using image correlation to align the current sequencing image to the template image on a sub-region, or by using non-linear transformations (e.g., a full six-parameter linear affine transformation). RTA generates a color matrix to correct cross-talk between color channels of the sequencing images. RTA implements empirical phasing correction to compensate noise in the sequencing images caused by phase errors. After different corrections are applied to the sequencing images, RTA extracts signal intensities for each spot location in the sequencing images. For example, for a given spot location, signal intensity may be extracted by determining a weighted average of the intensity of the pixels in a spot location. For example, a weighted average of the center pixel and neighboring pixels may be performed using bilinear or bicubic interpolation. In some implementations, each spot location in the image may comprise a few pixels (e.g., 1-5 pixels). RTA then spatially normalizes the extracted signal intensities to account for variation in illumination across the sampled imaged. For example, intensity values may be normalized such that a 5th and 95th percentiles have values of 0 and 1, respectively. The normalized signal intensities for the image (e.g., normalized intensities for each channel) may be used to calculate mean chastity for the plurality of spots in the image.

In some implementations, RTA uses an equalizer to maximize the signal-to-noise ratio of the extracted signal intensities. The equalizer may be trained (e.g., using least square estimation, adaptive equalization algorithm) to maximize the signal-to-noise ratio of cluster intensity data in sequencing images. In some implementations, the equalizer is a lookup table (LUT) bank with a plurality of LUTs with subpixel resolution, also referred to as “equalizer filters” or “convolution kernels.” By way of example only, the number of LUTs in the equalizer may depend on the number of subpixels into which pixels of the sequencing images can be divided. For example, if the pixels are divisible into n by n subpixels (e.g., 5×5 subpixels), then the equalizer generates n2 LUTs (e.g., 25 LUTs).

In some implementations of training the equalizer, data from the sequencing images is binned by well subpixel location. It should be understood that a “well” may include depressions (1404, 1462, 1464) of a flow cell (1400, 1450) or any other kind of reaction site (e.g., in a flow cell or otherwise). In an example of sequencing images being binned by well subpixel location, for a 5×5 LUT, 1/25th of the wells have a center that is in bin (1,1) (e.g., the upper left corner of a sensor pixel), 1/25th of the wells are in bin (1,2), and so on. The equalizer coefficients for each bin may be determined using least squares estimation on the subset of data from the wells corresponding to the respective bins. This way, the resulting estimated equalizer coefficients are different for each bin. Each LUT/equalizer filter/convolution kernel has a plurality of coefficients that are learned from the training. The number of coefficients in a LUT may correspond to the number of pixels that are used for base calling a cluster. For example, if a local grid of pixels (image or pixel patch) that is used to base call a cluster is of size p×p (e.g., 9×9 pixel patch), then each LUT has p2 coefficients (e.g., 81 coefficients). The training may produce equalizer coefficients that are configured to mix/combine intensity values of pixels that depict intensity emissions from a target cluster being base called and intensity emissions from one or more adjacent clusters in a manner that maximizes the signal-to-noise ratio. The signal maximized in the signal-to-noise ratio is the intensity emissions from the target cluster, and the noise minimized in the signal-to-noise ratio is the intensity emissions from the adjacent clusters, i.e., spatial crosstalk, plus some random noise (e.g., to account for background intensity emissions). The equalizer coefficients are used as weights and the mixing/combining includes executing element-wise multiplication between the equalizer coefficients and the intensity values of the pixels to calculate a weighted sum of the intensity values of the pixels, i.e., a convolution operation.

RTA then performs base calling by fitting a mathematical model to the optimized intensity data. Suitable mathematical models that can be used include, for example, a k-means clustering algorithm, a k-means-like clustering algorithm, expectation maximization clustering algorithm, a histogram based method, and the like. Four Gaussian distributions may be fit to the set of two-channel intensity data such that one distribution is applied for each of the four nucleotides represented in the data set. In some implementations, an expectation maximization (EM) algorithm may be applied. As a result of the EM algorithm, for each X, Y value (referring to each of the two channel intensities respectively) a value may be generated which represents the likelihood that a certain X, Y intensity value belongs to one of four Gaussian distributions to which the data is fitted. Where four bases give four separate distributions, each X, Y intensity value will also have four associated likelihood values, one for each of the four bases. The maximum of the four likelihood values indicates the base call. For example, if a cluster is “off” in both channels, the base call is G. If the cluster is “off” in one channel and “on” in another channel the base call is either C or T (depending on which channel is on), and if the cluster is “on” in both channels the base call is A.

In some implementations of RTA, the base calling errors get averaged out across many training examples. In some other implementations, the ground truth may be sourced using aligned genomic data, which may provide better quality because aligned genomic data may use reference genome and truth information that incorporate the knowledge gained from multiple sequencing platforms and sequencing runs to average out the noise. The ground truth may include base-specific intensity values (or feature values) that reliably represent intensity profiles of bases A, C, G, and T, respectively. A base caller like RTA base caller (1926) base calls clusters by processing the sequencing images and producing, for each base call, color-wise intensity values/outputs. The color-wise intensity values may be considered base-wise intensity values because, depending on the type of chemistry (e.g., 2-color chemistry or 4-color chemistry), the colors map to each of the bases A, C, G, and T. The base with the closest matching intensity profile is called.

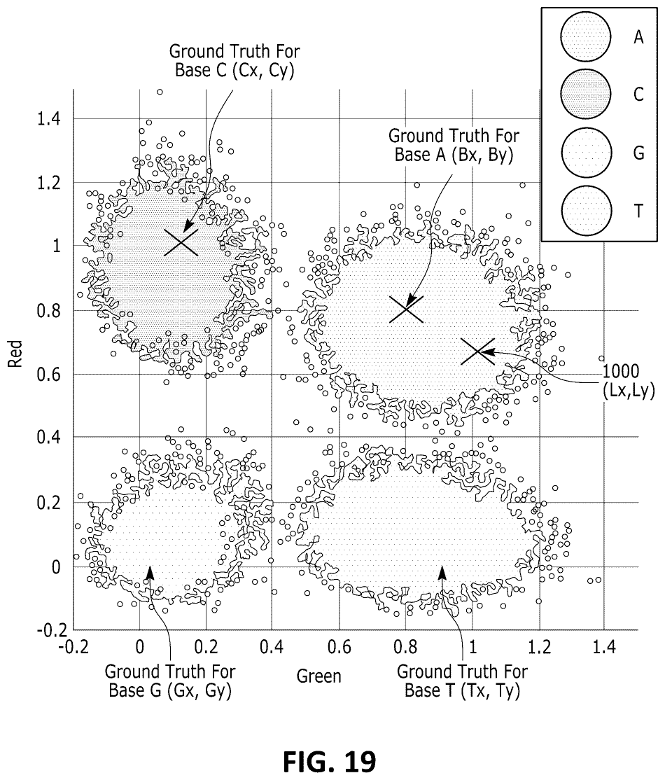

FIG. 19 shows one implementation of base-wise Gaussian fits that contain at their centers base-wise intensity targets that are used as ground truth values for error calculation during training. Base-wise intensity outputs produced by base caller (1926) for a multiplicity of base calls in the training data (e.g., tens, hundreds, thousands, or millions of base calls) are used to produce a base-wise intensity distribution. FIG. 19 shows a chart with four Gaussian clouds that are a probabilistic distribution of the base-wise intensity outputs of the bases A, C, G, and T, respectively. Intensity values at the centers of the four Gaussian clouds are used as the ground truth intensity targets (or feature value targets) of the ground truth for the bases A, C, G, and T, respectively, and referred to herein as the targets (e.g., intensity or feature value targets).

Consider that, during the training, input image data that is fed to base caller (1926) is annotated with base “A” as the ground truth base call. The ground truth also includes base-specific intensity values that reliably represent intensity profiles of bases A, C, G, and T, respectively. Thus, for example, the ground truth also includes, for base A, coordinates of an average intensity or average feature value for base A (i.e., a center of the green cloud in FIG. 19), as illustrated in FIG. 19 (feature values have been discussed herein later). Then, the target/desired output of the base caller (1926) is the intensity value or feature value at the center of the green cloud in FIG. 19, i.e., the intensity target for base A. Similarly, for base “C,” ground truth comprises the intensity value or feature value at the center of the blue cloud in FIG. 19, i.e., the intensity target (or the feature value target) for base C having coordinates (Cx,Cy). Similarly, for base “T,” ground truth comprises the intensity value or feature value at the center of the red cloud in FIG. 19, i.e., the intensity target (or the feature value target) for base T having coordinates (Tx, Ty). Also, for base “G,” ground truth comprises the intensity value or feature value at the center of the brown cloud in FIG. 19, i.e., the intensity target (or the feature value target) for base G having coordinates (Gx,Gy). Accordingly, targets or desired outputs during the training of base caller (1926) are the average intensities (or average feature values) for the respective bases A, C, G, and T after averaging in the training data. In one implementation, the trainer uses the least squares estimation to fit the coefficients of sharpening masks, to minimize the output error to these targets.

In some versions of the training, base caller (1926) applies the coefficients in a given sharpening mask to pixels of a sequencing image labelled with a given base. This includes element-wise multiplying the coefficients with the intensity values of the pixels and generating a weighted sum of the intensity values of a feature map, with the coefficients serving/acting/used as the weights. The feature map includes various features having corresponding feature values. The center of a cluster may not necessarily align with the center of a pixel of the sequencing images. To account for such misalignment, in the feature map generated from the sequencing images (where the feature map is generated by convolving a sharpening mask with a corresponding section of the image), a weighted feature value assigned to a cluster is generated by bilinear interpolation, e.g., where neighboring features are interpolated to generate the weighted feature value corresponding to a cluster. The interpolated feature value corresponding to the cluster then becomes the predicted output of base caller (1926) for that cluster. Then, based on a cost/error function (e.g., sum of squared errors (SSE)), an error (e.g., the least square error, the least means squared error) is calculated between the interpolated weighted feature value and the intensity target determined for the given base of the cluster (e.g., from the center of the corresponding intensity Gaussian fit as the average intensity observed for the given base). The cost function, such as the SSE, is a differentiable function used to estimate sharpening mask coefficients using an adaptive approach, and the derivatives of the error may be evaluated with respect to the coefficients, and these derivatives are then used to update the coefficients with values that minimize the error. This process is repeated until the updated coefficients do not reduce the error anymore.

In other implementations, batch least squares approach is used to train base caller (1926). For example, assume that the center of the green cloud in FIG. 19, i.e., the intensity target for base A is (Ax,Ay), which is the target or desired output (e.g., a target feature value) for base A base calls. Assume that during a sequencing run, a cluster (2000) has a weighted feature value represented at coordinate (Ix,Iy). In an example, base caller (1926) updates coefficients in a given sharpening mask, such that the intensity of cluster (2000) is transposed to the coordinates (Ax,Ay) from the coordinates (Ix,Iy). Thus, the training aims to minimize or reduce the distance between the coordinates (Ax,Ay) and (Ix,Iy).

By way of example only, the base-wise intensity distributions/Gaussian clouds shown in FIG. 19 may be generated on a well-by-well basis and corrected for noise by addition of a DC offset, amplification coefficient, and/or phasing parameter. This way, depending upon the well location of a particular well, the corresponding base-wise Gaussian clouds can be used to generate target intensity values for that particular well (or a cluster corresponding to the well). As noted above, a “well” may be understood to include depressions (1404, 1462, 1464) of a flow cell (1400, 1450) or any other kind of reaction site (e.g., in a flow cell or otherwise).

In some versions, a bias term is added to the dot product that produces the output of base caller (1926). During training, the bias parameter may be estimated using a similar approach used to learn the coefficients of the sharpening masks, e.g., least squares or least mean squares (LMS). In some implementations, the value for the bias parameter is a constant value equal to one, e.g., a value that does not vary with the input pixel intensities. There is one bias per set of coefficients. The bias is learned during the training and thereafter fixed for use during inference. The learned bias represents a DC offset that is used in every calculation during the inference, along with the learned coefficients of each sharpening mask. The bias accounts for random noise caused by different cluster sizes, different background intensities, varying stimulation responses, varying focus, varying sensor sensitivities, and varying lens aberrations. In yet other decision-directed implementations, the outputs of base caller (1926) are presumed to be correct for the training purposes.

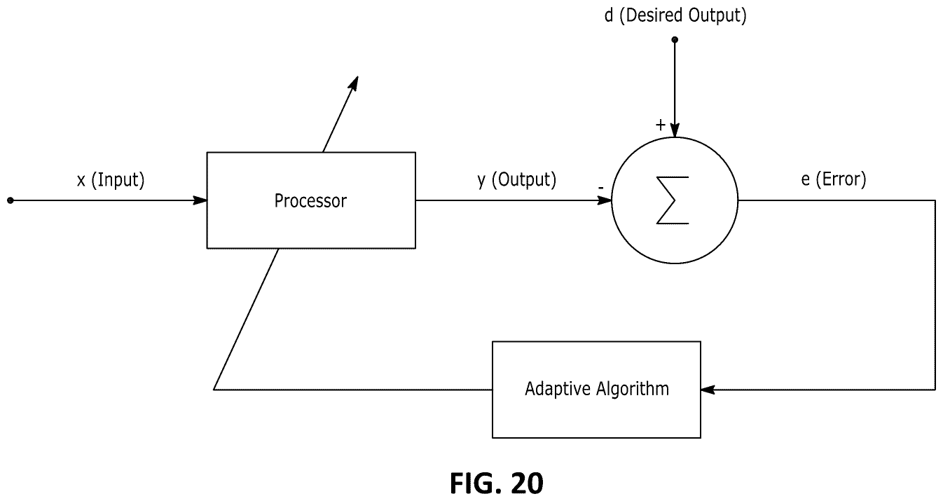

A trainer may train base caller (1926) and generate the trained coefficients of the sharpening masks using various training techniques. FIG. 20 shows one implementation of an adaptive technique that may be used to train base caller (1926), e.g., using an offline or online mode. Here, the logic is y=x.h+d, where x is the input pixel intensities, h is the sharpening mask coefficients, d is the DC offset. In some implementations, x and h are row and column vectors respectively, with length 81. This vector model is equivalent to a dot product of 9×9 matrices representing input pixels and coefficients. The cost is the expected value of error squared. The gradient update moves each coefficient in a direction that reduces the expected value of error squared. This leads to the following update:

$$ℏ ( n + 1 ) = ℏ ( n ) - \frac{μ}{2} ∇ C ( n ) = ℏ ( n ) + μ E \{ x ( n ) e * ( n ) \}$$

For most systems the expectation function E {x (n) e*(n)} must be approximated. This can be done with the following unbiased estimator

$$\hat{E} \{ x ( n ) e * ( n ) \} = \frac{1}{N} {\sum }_{i = 0}^{N - 1} x ( n - i ) e * ( n - i )$$

where N indicates the number of samples, we use for that estimate. The simplest case is N=1.

$$\hat{E} \{ x ( n ) e * ( n ) \} = x ( n ) e * ( n )$$

For that simple case the update algorithm follows as

$$ℏ ( n + 1 ) = ℏ ( n ) + μ x ( n ) e * ( n )$$

Indeed, this constitutes the update algorithm for the LMS filter.

In equations above, h is a vector of sharpening mask coefficients, x is a vector of input intensities, and e is the error for the calculation that was performed using the values in x, i.e., only 1 error term per output. Applying this update generates a new estimate of the coefficients that moves them in a direction that (on average) reduces the mean squared error (MSE). In some implementations, Mu is a small constant used to change the adaptation rate/convergence speed. A DC term update can be calculated in a similar way. A gain term update also can be calculated in a similar way.

In some implementations, since linear interpolation is applied on the coefficient sets, the updates are applied slightly differently in the following manner:

$$h ( q , n + 1 ) = h ( q , n ) + lambda\_q \cdot mu \cdot x ( n ) \cdot e ( n )$$

In the equation above, h (q, n) is weight q at cycle n, lambda_q is the linear interpolation weight for a particular set of coefficients and can include four updates per output due to linear interpolation in two dimensions. The recursive least-squares technique extends the least squares technique to a recursive algorithm.

### C. Examples of Structural Variation Graph Genome Generation

In some scenarios, a secondary analysis may be performed iteratively while sequence reads are generated by a sequencing system such as systems (1100, 1300, 1500, 1814) described herein. Secondary analyses may encompass both alignment of sequence reads to a reference sequence (e.g., the human reference genome sequence) and utilization of this alignment to detect differences between a sample and the reference. Secondary analyses may enable detection of genetic differences, variant detection and genotyping, identification of single nucleotide polymorphisms (SNPs), small insertions and deletion (indels) and structural changes in the DNA, such as copy number variants (CNVs) and chromosomal rearrangements.

By performing secondary analyses while sequence reads are generated, system (1100, 1300, 1500, 1814) may determine preliminary variant calls iteratively in real-time (or with zero or low latency). Final results of variant determinations may be available soon after (or immediately after) the end of a sequencing run. Alternatively, a sequencing run may be terminated early if variant calls are available with sufficient confidence during the run. In some scenarios, only information related to variant determinations (e.g., variant calls) is transferred off the sequencing system (1100, 1300, 1500, 1814). This may decrease, or minimize, the data bandwidth required in comparison to performing the variant determinations in a system that is external. In addition, only variant information may be sent to a computing system (e.g., a cloud computing system) for further processing. In this example, sequencing runs may be terminated prior to completion of an entire sequencing process. For example, if the identity of a pathogen of interest is determined after a number of sequencing cycles of a sequencing run, the sequencing run may be terminated. Thus, the time to a particular answer (e.g., pathogen identification) may be decreased. In some implementations, outputs and intermediate results of system (1100, 1300, 1500, 1814) may include histograms of duplicates, exact matches, single and double SNPs, and single and double indels.

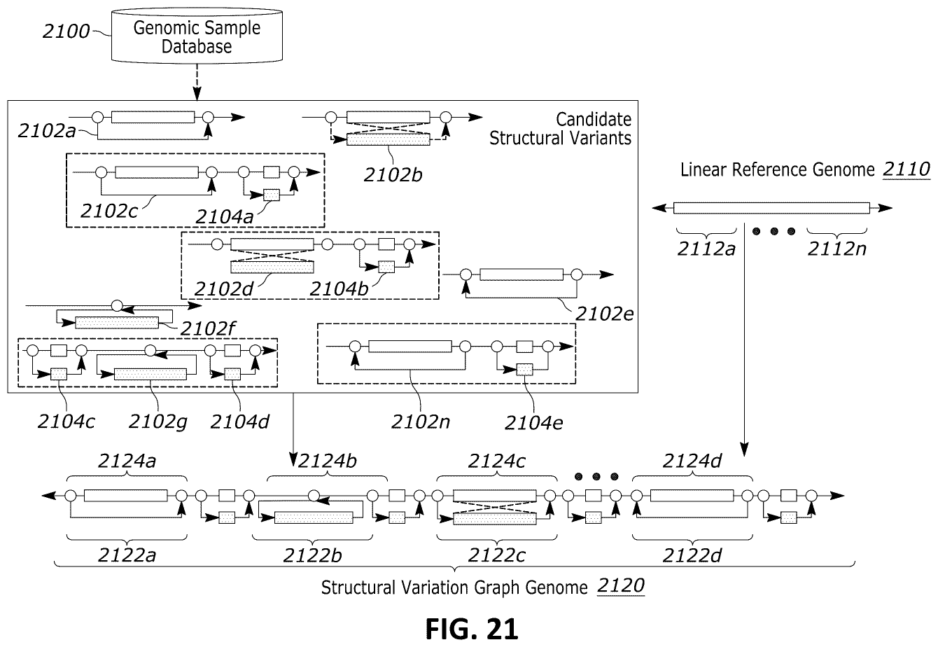

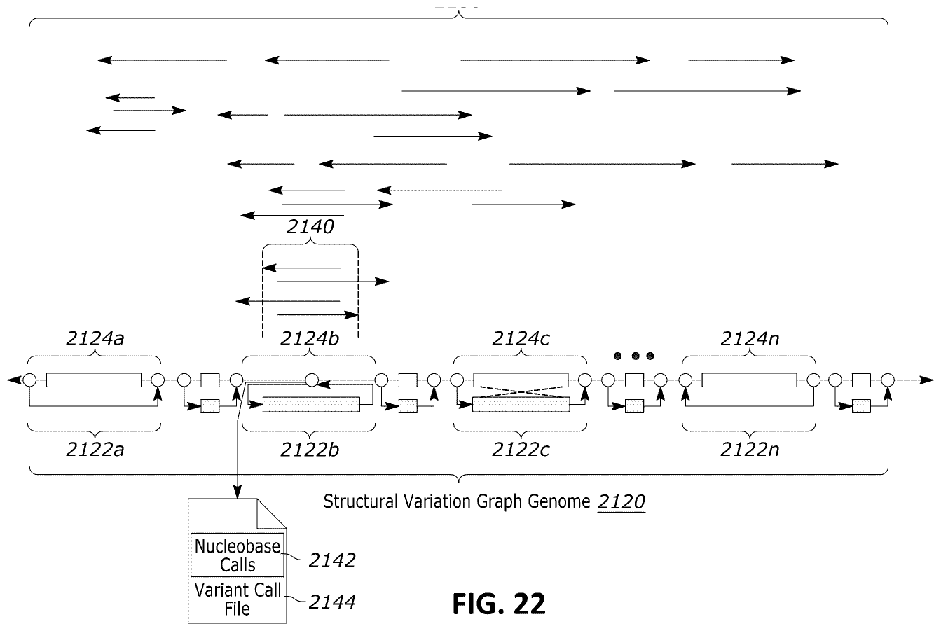

FIGS. 21-22 show examples of how systems (1100, 1300, 1500, 1814) as described herein may be used to generate and implement a structural variation graph genome. In particular, FIG. 21 illustrates an example of a sequencing system (1100, 1300, 1500, 1814) generating a structural variation graph genome (1120) comprising alternate contiguous sequences representing structural variant haplotypes and reference sequences representing reference haplotypes. FIG. 22 illustrates an example of sequencing system (1100, 1300, 1500, 1814) aligning nucleotide reads of a genomic sample with the structural variation graph genome (2120) and determining nucleobase calls for the genomic sample based on the aligned nucleotide reads.

As shown in FIG. 21, sequencing system (1100, 1300, 1500, 8114) identifies candidate structural variants (2102a-2102n) from a genomic sample database (2100) based on an occurrence threshold. For example, sequencing system (1100, 1300, 1500, 1814) identifies the candidate structural variants (2102a-2102n) that satisfy a threshold quantity of occurrences within the genomic sample database (2100). By selecting structural variants that satisfy a threshold count (e.g., 3 or more occurrences) or that satisfy a threshold frequency (e.g., 10%, 30% variant frequency) at target genomic coordinates in the genomic sample database (2100), in some implementations, sequencing system (1100, 1300, 1500, 1814) selects the candidate structural variants (2102a-2102n) from the genomic sample database (2100). The genomic sample database (2100) may include a variety of databases comprising nucleotide reads from a diverse set of genomic samples as will be apparent to those skilled in the art in view of the teachings herein.

As further indicated by FIG. 21, sequencing system (1100, 1300, 1500, 1814) identifies a variety of structural-variant types among the candidate structural variants (2102a-2102n). Based on satisfying a threshold quantity of occurrence, for instance, sequencing system (1100, 1300, 1500, 1814) identifies the candidate structural variants (2102a, 2102c) exhibiting deletions exceeding a threshold number of base pairs; the candidate structural variants (2102b, 2102d) exhibiting translocations; the candidate structural variants (2102f, 2102g) exhibiting insertions exceeding a threshold number of base pairs; and the candidate structural variants (2102e, 2102n) exhibiting duplications exceeding a threshold number of base pairs. For illustrative purposes and space constraints, FIG. 21 depicts the candidate structural variants (2102a-2102n) as merely illustrative examples. Sequencing system (1100, 1300, 1500, 1814) may identify, from the genomic sample database (2100), different types of structural variants (e.g., translocations, CNVs) and additional structural variants not depicted in FIG. 21.

From among the candidate structural variants (2102a-2102n), as further shown in FIG. 21, sequencing system (1100, 1300, 1500, 1814) selects structural variant haplotypes. In some cases, sequencing system (1100, 1300, 1500, 1814) selects structural variant haplotypes that satisfy an additional threshold quantity of occurrences at particular genomic regions, as categorized in the genomic sample database (2100). For example, in certain implementations, sequencing system (1100, 1300, 1500, 1814) selects structural variant haplotypes that satisfy a threshold variant frequency (e.g., 15%, 25%) or a threshold count (3, 10) at target genomic coordinates corresponding to the candidate structural variants (2102a-2102n).

In addition, or in the alternative, to an occurrence threshold, sequencing system (1100, 1300, 1500, 1814) may select structural variant haplotypes that are adjacent to flanking variants within contiguous sequences of the genomic sample database (2100). In some cases, the flanking variants are in phase with respective structural variant haplotypes in nucleotide sequences of the genomic sample database (2100). As indicated by FIG. 21, for instance, sequencing system (1100, 1300, 1500, 1814) determines the candidate structural variant (1102c) is in phase with a flanking variant (2104a) within a contiguous sequence (or other nucleotide sequence) of the genomic sample database (2100). Similarly, sequencing system (1100, 1300, 1500, 1814) determines the candidate structural variant (2102d) is in phase with a flanking variant (2104b), the candidate structural variant (2102g) is in phase with flanking variants (2104c, 2104d), and the candidate structural variant (2102n) is in phase with a flanking variant (2104e)—each within respective contiguous sequences (or other nucleotide sequences) of the genomic sample database (2100). Accordingly, as indicated by the dotted-line circles of FIG. 21, in some scenarios, sequencing system (1100, 1300, 1500, 1814) selects the candidate structural variants (2102c, 2102d, 2102g, 2102n) as structural variant haplotypes to include within the structural variation graph genome (2120).

In addition to selecting the candidate structural variants (2102c, 2102d, 2102g, 2102n) as structural variant haplotypes, as further shown in FIG. 21, sequencing system (1100, 1300, 1500, 1814) identifies, from a linear reference genome (2110), reference haplotypes (2112a-2112n) corresponding to the selected structural variant haplotypes. For example, in some cases, sequencing system (1100, 1300, 1500, 1814) identifies the reference haplotypes (2112a-2112n) at genomic coordinates of the linear reference genome (2110) corresponding to the selected structural variant haplotypes. Indeed, sequencing system (1100, 1300, 1500, 1814) may identify genomic coordinates of the reference haplotypes (2112a-2112n) above which to incorporate the selected variant haplotypes as liftover groups in the structural variation graph genome (2120).

As further shown in FIG. 21, sequencing system (1100, 1300, 1500, 1814) generates the structural variation graph genome (2120). As shown, the structural variation graph genome (2120) comprises alternate contiguous sequences (2122a, 2122b, 2122c, 2122n) representing the selected structural variant haplotypes. In some scenarios, one or more of the alternate contiguous sequences also include flanking variants (2104a-2104e).

To organize different structural variant haplotypes for a particular genomic region, in certain cases, sequencing system (1100, 1300, 1500, 1814) generates the structural variation graph genome (2120) by ordering different subsets of alternate contiguous sequences corresponding to different genomic regions according to structural variant frequency within the genomic sample database (2100). Accordingly, in some cases, sequencing system (1100, 1300, 1500, 1814) generates the structural variation graph genome (2120) by ordering: (i) a first subset of alternate contiguous sequences corresponding to a first genomic region according to frequency within the genomic sample database (2100); and (ii) a second subset of alternate contiguous sequences corresponding to a second genomic region according to frequency within the genomic sample database (2100).

As further shown in FIG. 21, the structural variation graph genome (11120) comprises reference sequences (2124a, 2124b, 2124c, 2124n) representing the reference haplotypes corresponding to the selected structural variant haplotypes. Indeed, in some cases, the structural variation graph genome (2120) includes and is backwards compatible with the linear reference genome (2110). Sequencing system (1100, 1300, 1500, 1814) may generate the structural variation graph genome (2120) by constructing a hash table or other organizational structure.

In addition, or in the alternative, to generating the structural variation graph genome (2120), in some embodiments, sequencing system (1100, 1300, 1500, 1814) aligns nucleotide reads of a genomic sample with the structural variation graph genome (2120) and determines nucleobase calls for the genomic sample based on the aligned nucleotide reads. FIG. 22 depicts an example of one such implementation of the structural variation graph genome (2120). As shown in FIG. 22, sequencing system (1100, 1300, 1500, 1814) identifies or receives nucleotide reads (2130) for a genomic sample. In some cases, for instance, sequencing system (1100, 1300, 1500, 1814) receives base-call data (e.g., BCL file or FASTQ file) from a sequencing device (1100, 2300, 2500, 2810), which has sequenced oligonucleotides extracted from the genomic sample and determined individual nucleobase calls for the nucleotide reads (2130) in the base-call data. Depending on the type of sequencing performed, in some scenarios, sequencing system (1100, 1300, 1500, 1814) identifies either single-end reads or paired-end reads and either short nucleotide reads (e.g., <300 base pairs or <10,000 base pairs) or long nucleotide reads (e.g., >300 base pairs or >10,000 base pairs) as the nucleotide reads (2130).

As further shown in FIG. 22, sequencing system (1100, 1300, 1500, 1814) aligns the nucleotide reads (2130) with different sequences of the structural variation graph genome (2120). In particular, sequencing system (1100, 1300, 1500, 1814) aligns a subset of nucleotide reads (2140) from the nucleotide reads (2130) with the alternate contiguous sequence (2122b) of the structural variation graph genome (2120). As FIG. 22 suggests, some or all of the subset of nucleotide reads (2140) overlap with the alternate contiguous sequence (2122b). In this particular example, the subset of nucleotide reads (2140) overlap with the alternate contiguous sequence (2122b) representing the candidate structural variant (2102f)—that is, an insertion exceeding a threshold number of bases.

In addition to the alternate contiguous sequence (2122b), in some cases, sequencing system (1100, 1300, 1500, 1814) aligns different subsets of nucleotide reads for the genomic sample with one or more of the alternate contiguous sequences (2122a, 2122c, 2122n) or the reference sequences (2124a-2124n) of the structural variation graph genome (2120). Accordingly, in certain implementations, sequencing system (1100, 1300, 1500, 1814) aligns certain nucleotide reads with alternate contiguous sequences representing different types of structural variant haplotypes, including, but not limited to, insertions, deletions, duplications, inversions, translocations, or CNVs. Likewise, in some cases, sequencing system (1100, 1300, 1500, 1814) aligns certain nucleotide reads with reference sequences representing reference haplotypes from the linear reference genome.

As further shown in FIG. 22, sequencing system (1100, 1300, 1500, 1814) determines nucleobase calls (2142) for the genomic sample based on the subset of nucleotide reads (2140) aligning with the alternate contiguous sequence (2122b). For example, sequencing system (1100, 1300, 1500, 1814) generates one or more variant calls corresponding to a structural variant haplotype represented by the alternate contiguous sequence (2122b). Sequencing system (1100, 1300, 1500, 1814) determines such variant calls in part because an alignment of the subset of nucleotide reads (2140) with the alternate contiguous sequence (2122b) exhibits better mapping metrics, base-call-quality metrics, or other sequencing metrics than an alignment of the subset of nucleotide reads (2140) with the reference sequence (2124b). In some embodiments, sequencing system (1100, 1300, 1500, 1814) generates a variant call file (2144) comprising the nucleobase calls (2142) along with other nucleobase calls based on read alignments. As noted above, sequencing system (1100, 1300, 1500, 1814) may select structural variant haplotypes from a genomic sample database to include within a structural variation graph genome.

By way of further example only, base calling and/or other aspects of system (1100, 2300, 2500, 2800, 2814) may be carried out in accordance with at least some of the teachings of U.S. Pat. App. No. 63/367,075, entitled “GENERATING AND IMPLEMENTING A STRUCTURAL VARIATION GRAPH GENOME,” filed Jun. 27, 2022, the disclosure of which is incorporated by reference herein, in its entirety; U.S. Pat. App. No. 63/223,408, entitled SPECIALIST SIGNAL PROFILERS FOR BASE CALLING,” filed Jul. 19, 2021, the disclosure of which is incorporated by reference herein, in its entirety; U.S. patent application Ser. No. 17/876,528, entitled “Base Calling Using Multiple Base Caller Models,” filed Jul. 28, 2022, the disclosure of which is incorporated by reference herein, in its entirety; U.S. Pat. No. 10,152,776, entitled “Optical Distortion Correction for Imaged Samples,” issued Nov. 20, 2018, the disclosure of which is incorporated by reference herein, in its entirety; U.S. Pat. No. 10,540,783, entitled “Image Analysis Useful for Patterned Objects,” issued Jan. 21, 2020, the disclosure of which is incorporated by reference herein, in its entirety; U.S. Pat. No. 10,689,696, entitled “Methods and Systems for Analyzing Image Data,” issued Jun. 23, 2020, the disclosure of which is incorporated by reference herein, in its entirety; U.S. Pat. No. 8,965,076, entitled “Data Processing System and Methods,” issued Feb. 24, 2015, the disclosure of which is incorporated by reference herein, in its entirety; U.S. Pat. No. 11,188,778, entitled “Equalization-Based Image Processing and Spatial Crosstalk Attenuator,” issued Nov. 30, 2021, the disclosure of which is incorporated by reference herein, in its entirety; and/or U.S. Pub. No. 2020/0302297, entitled “Artificial Intelligence-Based Base Calling,” published Sep. 24, 2020, the disclosure of which is incorporated by reference herein, in its entirety.

### VII. Examples of Combinations

The following examples relate to various non-exhaustive ways in which the teachings herein may be combined or applied. The following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

Example 1. A system, comprising: an interface configured to receive a substrate including an active area; a pump configured to flow a reagent from a reagent reservoir toward the active area and to flow a sample slug of a sample of interest toward the active area; and an optical assembly including an objective and a focus tracking module; wherein the focus tracking module is configured to detect a position of a meniscus of the reagent between the reagent and the sample slug; the pump is configured to flow the sample slug over the active area based on the position of the meniscus; and the focus tracking module is configured to determine a z-position of the interface and the optical assembly is configured to adjust a position of the objective based on the z-position determined.

Example 2. The system of Example 1, wherein the substrate comprises a channel and the focus tracking module is configured to detect the position of the meniscus within the channel.

Example 3. The system of any one the preceding Examples, wherein a first air slug is positioned on a first side of the sample slug, between the sample slug and the reagent, and a second air slug is positioned on a second side of the sample slug, opposite the first side, between the sample slug and the reagent.

Example 4. The system of Example 3, wherein the meniscus is located between the reagent and the first air slug.

Example 5. The system of any one the preceding Examples, wherein the pump is configured to position the first air slug and the second air slug outside of the active area.

Example 6. The system of any one the preceding Examples, wherein the substrate comprises a plurality of channels and the focus tracking module is configured to sweep across the plurality of channels to detect the position of the meniscus of the reagent between the reagent and the sample slug in each channel of the plurality of channels.

Example 7. The system of any one the preceding Examples, comprising: a sample cartridge interface configured to receive a sample cartridge; a sample loading manifold assembly; a first fluidic line fluidly coupling the interface and the sample loading manifold assembly; and a second fluidic line fluidly coupling the sample loading manifold assembly and the sample cartridge interface.

Example 8. The system of Example 7, wherein a total length of the first fluidic line and the second fluidic line together is greater than or equal to about 1 meter and less than or equal to about 3 meters.

Example 9. The system of Example 8, wherein the total length of the first fluidic line and the second fluidic line together is approximately 2 meters.

Example 10. The system of any one the preceding Examples, wherein the pump is a syringe pump.

Example 11. The system of any one the preceding Examples, wherein the pump is configured to push the sample slug into the plurality of channels of the substrate.

Example 12. The system of any one the preceding Examples, wherein a volume of the sample slug is greater than or equal to about 100 microliters and less than or equal to about 200 microliters.

Example 13. The system of Example 12, wherein the volume of the sample slug is approximately 150 microliters.

Example 14. The system of any one of Examples 1-9, 12, and 13, wherein the pump comprises a positive pressure source.

Example 15. The system of any one the preceding Examples, wherein the pump is positioned upstream of the flow cell interface.

Example 16. The system of any one the preceding Examples, wherein the pump is positioned downstream of the flow cell interface.

Example 17. The system of any one the preceding Examples, wherein the substrate is part of a flow cell.

Example 18. An apparatus, comprising: a flow cell having a channel, the channel including an active area; a sample cartridge configured to retain a sample of interest; and a system comprising: a pump configured to flow a reagent from a reagent reservoir into the channel of the flow cell and to flow a sample slug of the sample of interest into the channel of the flow cell; and an optical assembly including an objective and a focus tracking module; wherein the focus tracking module is configured to detect a position of a meniscus of the reagent between the reagent and the sample slug; and the pump is configured to flow the sample slug over the active area of the channel of the flow cell based on the position of the meniscus.

Example 19. The apparatus of Example 18, wherein the focus tracking module is configured to detect the position of the meniscus within the channel of the flow cell.

Example 20. The apparatus of any one of Examples 18-19, wherein a first air slug is positioned on a first side of the sample slug, between the sample slug and the reagent, and a second air slug is positioned on a second side of the sample slug, opposite the first side, between the sample slug and the reagent.

Example 21. The apparatus of Example 20, wherein the meniscus is located between the reagent and the first air slug.

Example 22. The apparatus of any one of Examples 20-21, wherein the pump is configured to position the first air slug and the second air slug outside of the active area of the channel of the flow cell.

Example 23. The apparatus of any one of Examples 18-22, wherein the flow cell comprises a plurality of channels and the focus tracking module is configured to sweep across the plurality of channels to detect the position of the meniscus of the reagent between the reagent and the sample slug in each channel of the plurality of channels.

Example 24. The apparatus of any one of Examples 18-23, wherein: the system comprises a flow cell interface configured to receive the flow cell; the focus tracking module is configured to determine a z-position of the flow cell interface; and the optical assembly is configured to adjust a position of the objective based on the z-position determined.

Example 25. The apparatus of any one of Examples 18-24, wherein the system comprises: a flow cell interface; a sample cartridge interface configured to receive the sample cartridge; a sample loading manifold assembly; a first fluidic line fluidly coupling the flow cell interface and the sample loading manifold assembly; and a second fluidic line fluidly coupling the sample loading manifold assembly and the sample cartridge interface.

Example 26. The apparatus of Example 25, wherein a total length of the first fluidic line and the second fluidic line together is greater than or equal to about 1 meter and less than or equal to about 3 meters.

Example 27. The apparatus of Example 26, wherein the total length of the first fluidic line and the second fluidic line together is approximately 2 meters.

Example 28. The apparatus of any one of Examples 18-27, wherein the pump is a syringe pump.

Example 29. The apparatus of any one of Examples 18-28, wherein the pump is configured to push the sample slug into the channel of the flow cell.

Example 30. The apparatus of any one of Examples 18-29, wherein a volume of the sample slug is greater than or equal to about 100 microliters and less than or equal to about 200 microliters.

Example 31. The apparatus of Example 30, wherein the volume of the sample slug is approximately 150 microliters.

Example 32. An apparatus, comprising: a flow cell having a channel, the channel including an active area; and a system, comprising: a pump configured to flow a reagent from a reagent reservoir into the channel of the flow cell and to flow a sample slug of a sample of interest into the channel of the flow cell; and an optical assembly including a sensor; wherein the sensor is configured to detect a position of a meniscus of the reagent between the reagent and the sample slug; and the pump is configured to flow the sample slug over the active area of the channel of the flow cell based on the position of the meniscus.

Example 33. The apparatus of Example 32, wherein the sensor is configured to detect the position of the meniscus within the channel of the flow cell.

Example 34. The apparatus of any one of Examples 32-33, wherein a first air slug is positioned on a first side of the sample slug, between the sample slug and the reagent, and a second air slug is positioned on a second side of the sample slug, opposite the first side, between the sample slug and the reagent.

Example 35. The apparatus of Example 34, wherein the meniscus is located between the reagent and the first air slug.

Example 36. The apparatus of any one of Examples 34-35, wherein the pump is configured to position the first air slug and the second air slug outside of the active area of the channel of the flow cell.

Example 37. The apparatus of any one of Examples 32-36, wherein the flow cell comprises a plurality of channels and the sensor of the optical assembly is configured to sweep across the plurality of channels to detect the position of the meniscus of the reagent between the reagent and the sample slug in each channel of the plurality of channels.

Example 38. The apparatus of any one of Examples 32-37, wherein: the system comprises a flow cell interface configured to receive the flow cell; the sensor of the optical assembly is a focus tracking module configured to determine a z-position of the flow cell interface; and the optical assembly is configured to adjust a position of an objective of the optical assembly based on the z-position determined.

Example 39. The apparatus of any one of Examples 32-38, wherein the system comprises: a flow cell interface; a sample cartridge interface configured to receive a sample cartridge to retain the sample of interest; a sample loading manifold assembly; a first fluidic line fluidly coupling the flow cell interface and the sample loading manifold assembly; and a second fluidic line fluidly coupling the sample loading manifold assembly and the sample cartridge interface.

Example 40. The apparatus of Example 39, wherein a total length of the first fluidic line and the second fluidic line together is greater than or equal to about 1 meter and less than or equal to about 3 meters.

Example 41. The apparatus of Example 40, wherein the total length of the first fluidic line and the second fluidic line is approximately 2 meters.

Example 42. The apparatus of any one of Examples 32-41, wherein the pump is a syringe pump.

Example 43. The apparatus of Example 42, wherein the pump is configured to push the sample slug into the channel of the flow cell.

Example 44. The apparatus of any one of Examples 32-43, wherein a volume of the sample slug is greater than or equal to about 100 microliters and less than or equal to about 200 microliters.

Example 45. The apparatus of Example 44, wherein the volume of the sample slug is approximately about 150 microliters.

Example 46. A method, comprising: flowing a reagent from a reagent reservoir into a channel of a flow cell; flowing a sample slug of a sample of interest into the channel of the flow cell; detecting a position of a meniscus of the reagent between the reagent and the sample slug; determining the position of the sample slug based on the detected position of the meniscus; and flowing the sample slug over an active area of the channel of the flow cell based on the determined position of the sample slug.

Example 47. The method of Example 46, wherein the position of the meniscus is detected within the channel of the flow cell.

Example 48. The method of any one of Examples 46-47, comprising: positioning a first air slug on a first side of the sample slug, between the sample slug and the reagent; and positioning a second air slug on a second side of the sample slug, opposite the first side, between the sample slug and the reagent.

Example 49. The method of Example 48, wherein the meniscus is located between the reagent and the first air slug.

Example 50. The method of any one of Examples 48-49, comprising flowing the sample slug over the active area such that the first air slug and the second air slug are outside of the active area.

Example 51. The method of any one of Examples 46-50, comprising: flowing the reagent from the reagent reservoir into a second channel of the flow cell; flowing a second sample slug of a second sample of into the second channel of the flow cell; sweeping a focus tracking module across the channel and the second channel; detecting the position of the meniscus of the reagent between the reagent and the sample slug in the channel and a position of a second meniscus of the reagent between the reagent and the second sample in the second channel; determining the position of the sample slug and the position of the second sample slug based on the detected positions of the meniscus and the second meniscus; and flowing the sample slug over an active area of the channel and flowing the second sample slug over a second active area of the second channel based on the determined positions of the sample slug and the second sample slug.

Example 52. The method of any one of Examples 46-51, wherein the position of the meniscus is detected by a focus tracking module.

Example 53. The method of Example 52, comprising determining a z-position of a flow cell interface, configured to receive the flow cell, with the focus tracking module and adjusting a position of an objective of an optical assembly based on the z-position determined.

Example 54. The method of any one Examples 46-53, comprising flowing the sample slug from a sample cartridge interface to the flow cell through at least one fluidic line.

Example 55. The method of Example 54, wherein a length of the at least one fluidic line is greater than or equal to about 1 meter and less than or equal to about 3 meters.

Example 56. The method of Example 55, wherein the length of the at least one fluidic line is approximately 2 meters.

Example 57. The method of any one of Examples 46-55, wherein the reagent and the sample slug are flowed into the channel of the flow cell via a pump.

Example 58. The method of Example 57, wherein the pump is a syringe pump.

Example The method of any one of Examples 57-58, wherein the pump is configured to push the sample slug into the channel of the flow cell.

Example 60. The method of any one of Examples 46-59, wherein a volume of the sample slug is greater than or equal to about 100 microliters and less than or equal to about 200 microliters.

Example 61. The method of Example 60, wherein the volume of the sample slug is approximately 150 microliters.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

As used herein, an element or step recited in the singular and proceeded with the word “a” or “an” should be understood as not excluding plural of said elements or steps, unless such exclusion is explicitly stated. Furthermore, references to “one implementation” are not intended to be interpreted as excluding the existence of additional implementations that also incorporate the recited features. Moreover, unless explicitly stated to the contrary, implementations “comprising,” “including,” or “having” an element or a plurality of elements having a particular property may include additional elements whether or not they have that property. Moreover, the terms “comprising,” including,” having,” or the like are interchangeably used herein.

The terms “substantially,” “approximately,” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

There may be many other ways to implement the subject technology. Various functions and elements described herein may be partitioned differently from those shown without departing from the scope of the subject technology. Various modifications to these implementations may be readily apparent to those skilled in the art, and generic principles defined herein may be applied to other implementations. Thus, many changes and modifications may be made to the subject technology, by one having ordinary skill in the art, without departing from the scope of the subject technology. For instance, different numbers of a given module or unit may be employed, a different type or types of a given module or unit may be employed, a given module or unit may be added, or a given module or unit may be omitted.

Underlined and/or italicized headings and subheadings are used for convenience only, do not limit the subject technology, and are not referred to in connection with the interpretation of the description of the subject technology. All structural and functional equivalents to the elements of the various implementations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

1. A system, comprising:
an interface configured to receive a substrate including an active area;
a pump configured to flow a reagent from a reagent reservoir toward the active area and to flow a sample slug of a sample of interest toward the active area; and
an optical assembly including an objective and a focus tracking module; wherein
the focus tracking module is configured to detect a position of a meniscus of the reagent between the reagent and the sample slug;
the pump is configured to flow the sample slug over the active area based on the position of the meniscus; and
the focus tracking module is configured to determine a z-position of the interface and the optical assembly is configured to adjust a position of the objective based on the z-position determined.

2. The system of claim 1, wherein the substrate comprises a channel and the focus tracking module is configured to detect the position of the meniscus within the channel.

3. The system of claim 1, wherein a first air slug is positioned on a first side of the sample slug, between the sample slug and the reagent, and a second air slug is positioned on a second side of the sample slug, opposite the first side, between the sample slug and the reagent.

4. The system of claim 3, wherein the meniscus is located between the reagent and the first air slug.

5. The system of claim 3, wherein the pump is configured to position the first air slug and the second air slug outside of the active area.

6. The system of claim 1, wherein the substrate comprises a plurality of channels and the focus tracking module is configured to sweep across the plurality of channels to detect the position of the meniscus of the reagent between the reagent and the sample slug in each channel of the plurality of channels.

7. The system of claim 1, comprising: a sample cartridge interface configured to receive a sample cartridge; a sample loading manifold assembly; a first fluidic line fluidly coupling the interface and the sample loading manifold assembly; and a second fluidic line fluidly coupling the sample loading manifold assembly and the sample cartridge interface.

8. The system of claim 7, wherein a total length of the first fluidic line and the second fluidic line together is greater than or equal to about 1 meter and less than or equal to about 3 meters.

9. The system of claim 8, wherein the total length of the first fluidic line and the second fluidic line together is approximately 2 meters.

10. The system of claim 1, wherein the pump is a syringe pump.

11. The system of claim 6, wherein the pump is configured to push the sample slug into the plurality of channels of the substrate.

12. The system of claim 1, wherein a volume of the sample slug is greater than or equal to about 100 microliters and less than or equal to about 200 microliters.

13. The system of claim 12, wherein the volume of the sample slug is approximately 150 microliters.

14. The system of claim 1, wherein the pump comprises a positive pressure source.

15. The system of claim 1, wherein the pump is positioned upstream of the interface.

16. The system of claim 1, wherein the pump is positioned downstream of the interface.

17. The system of claim 1, wherein the substrate is part of a flow cell.

18. An apparatus, comprising:
a flow cell having a channel, the channel including an active area;
a sample cartridge configured to retain a sample of interest; and
a system comprising: a pump configured to flow a reagent from a reagent reservoir into the channel of the flow cell and to flow a sample slug of the sample of interest into the channel of the flow cell; and an optical assembly including an objective and a focus tracking module; wherein
the focus tracking module is configured to detect a position of a meniscus of the reagent between the reagent and the sample slug; and
the pump is configured to flow the sample slug over the active area of the channel of the flow cell based on the position of the meniscus.

19-23. (canceled)

24. The apparatus of claim 18, wherein: the system comprises a flow cell interface configured to receive the flow cell; the focus tracking module is configured to determine a z-position of the flow cell interface; and the optical assembly is configured to adjust a position of the objective based on the z-position determined.

25. The apparatus of claim 18, wherein the system comprises: a flow cell interface; a sample cartridge interface configured to receive the sample cartridge; a sample loading manifold assembly; a first fluidic line fluidly coupling the flow cell interface and the sample loading manifold assembly; and a second fluidic line fluidly coupling the sample loading manifold assembly and the sample cartridge interface.

26-61. (canceled)
